(19) United States
(12) Patent Application Publication
(10) Pub. No.: US 2016/0234525 A1
(43) Pub. Date: Aug. 11, 2016

(54) METHOD AND APPARATUS FOR DEPTH INTRA ENCODING AND METHOD AND APPARATUS FOR DEPTH INTRA DECODING

(71) Applicant: SAMSUNG ELECTRONICS CO., LTD., Suwon-si (KR)

(72) Inventors: Jin-young LEE, Hwaseong-si (KR); Min-woo PARK, Yongin-si (KR); Yong-jin CHO, Seoul (KR); Byeong-doo CHOI, Suwon-si (KR)

(73) Assignee: SAMSUNG ELECTRONICS CO., LTD., Suwon-si (KR)

(21) Appl. No.: 15/098,834

(22) Filed: Apr. 14, 2016

Related U.S. Application Data
(63) Continuation of application No. PCT/KR2014/009615, filed on Oct. 14, 2014.
(60) Provisional application No. 61/890,451, filed on Oct. 14, 2013.

(51) Int. Cl. H04N 19/597; H04N 19/33; H04N 19/159; H04N 19/177; H04N 19/52; H04N 19/139; H04N 19/176; H04N 19/11; H04N 19/593

(52) U.S. Cl. CPC H04N 19/597; H04N 19/11; H04N 19/33; H04N 19/159; H04N 19/593; H04N 19/52; H04N 19/139; H04N 19/176; H04N 19/177

(57) ABSTRACT

An inter-layer video encoding method includes configuring at least one prediction mode as a simplified depth coding (SDC) mode; determining a prediction mode with respect to a current block of a depth image; generating a prediction block of the current block by using the prediction mode; and generating a bitstream by encoding the depth image by using the prediction block.

### TECHNICAL FIELD

The inventive concept relates to a method of encoding and decoding an image, and more particularly, to an in-screen prediction method to be used in a method and apparatus for decoding/encoding a depth image of a video.

### BACKGROUND ART

A stereoscopic image refers to a three-dimensional (3D) image that provides image information simultaneously with shape information regarding a depth and a space. While a stereo image provides images corresponding to different viewpoints to left and right eyes, a stereoscopic image provides an image as if an observer views the image from a different direction whenever the observer changes viewpoint. Therefore, in order to generate stereoscopic images, images captured at various viewpoints are necessary.

Images captured at various viewpoints to generate a stereoscopic image have an enormous amount of data. Therefore, in consideration of network infrastructures and ground wave bandwidth, it is nearly impossible to display a stereoscopic image even when the stereoscopic image is coded by using an encoding apparatus that is optimized to single-view video coding, e.g., MPEG-2, H.264/AVC, and HEVC.

Therefore, a multiview (multilayer) image encoding apparatus is necessary in order to generate a stereoscopic image. In particular, it needs to develop a technique for efficiently reducing redundancy between time points and viewpoints.

For example, a multiview video codec may improve compression rate by compressing a basic viewpoint by using a single-view video encoding technique and encoding expanded viewpoints with reference to the basic viewpoint. In addition, by additionally encoding auxiliary data such as a depth image, an image including more viewpoints than those input from a decoding end of the image may be generated. Here, a depth image is used for synthesizing intermediate viewpoint images, rather than directly being displayed to a user. However, when the depth image degrades, image quality of a synthesized image degrades. Therefore, it is necessary for a multiview video codec to effectively compress a depth image, as well as a multiview video.

### TECHNICAL SOLUTION

According to an aspect of the inventive concept, there is provided an inter-layer video encoding method including: configuring at least one prediction mode as a simplified depth coding (SDC) mode; determining a prediction mode with respect to a current block of a depth image; generating a prediction block of the current block by using the prediction mode; and generating a bitstream by encoding the depth image by using the prediction block.

The configuring of the at least one prediction mode as the SDC mode may include configuring at least one of a DC mode, a planar mode, an angular mode, a depth modeling mode (DMM), and a most probable mode (MPM) as the SDC mode.

The configuring of the at least one prediction mode as the SDC mode may include setting the SDC mode to be different according to a size of a coding unit or a size of a prediction unit.

The generating of the bitstream by encoding the depth image may include, when determined prediction mode corresponds to the SDC mode, not encoding residual data that is difference between the prediction block and the current block or partially encoding the residual data.

The partially encoding of the residual data may include averaging and encoding entire or some of the residual data.

The averaging and encoding of some of the residual data may include averaging and encoding an upper left pixel value, an upper right pixel value, a lower left pixel value, and a lower right pixel value of a residual block that is difference between the prediction block and the current block.

The averaging and encoding of some of the residual data may include averaging values of some pixels in a residual block that is difference between the prediction block and the current block, and locations of the some pixels in the residual block are determined based on at least one of the prediction mode, and the size of the coding unit or the prediction unit.

According to an aspect of the inventive concept, there is provided an inter-layer video encoding apparatus including: a simplified depth coding (SDC) mode configuration unit configured to configure one or more prediction modes as SDC modes; a prediction mode determiner configured to determine a prediction mode with respect to a current block of a depth image; a prediction block generator configured to generate a prediction block of the current block by using the prediction mode; and an encoder configured to encode the depth image by using the prediction block to generate a bitstream.

The SDC mode configuration unit may configure at least one prediction mode of a DC mode, a planar mode, an angular mode, a depth modeling mode (DMM), and a most probable mode (MPM) as the SDC mode.

The SDC mode configuration unit may configure the SDC mode to be different according to a size of a coding unit or a size of a prediction unit.

When determined prediction mode corresponds to the SDC mode, the encoder may not encode residual data that is difference between the prediction block and the current block or partially encodes the residual data.

The encoder may average and encode entire or some of the residual data.

The encoder may average and encode an upper left pixel value, an upper right pixel value, a lower left pixel value, and a lower right pixel value of a residual block that is difference between the prediction block and the current block.

The encoder may average values of some pixels in a residual block that is difference between the prediction block and the current block, and locations of the some pixels in the residual block are determined based on at least one of the prediction mode, and the size of the coding unit or the prediction unit.

According to an aspect of the inventive concept, there is provided a non-transitory computer readable recording medium having recorded thereon a computer program for implementing the inter-layer video decoding method.

According to an aspect of the inventive concept, there is provided an inter-layer video decoding method including: obtaining prediction mode regarding a current block of a depth image from a bitstream; determining whether the prediction mode is a simplified depth coding (SDC) mode; generating a prediction block for the current block by using the prediction mode, according to a result of the determining of whether the prediction mode is the SDC mode; and decoding the depth image by using the prediction block.

The SDC mode may include at least one of a DC mode, a planar mode, an angular mode, a depth modeling mode (DMM), and a most probable mode (MPM).

The generating of the prediction block for the current block may include, when the prediction mode is the SDC mode, not decoding residual data that is difference between the prediction block and the current block or partially decoding the residual data.

### Advantageous Effects

According to inter-layer video decoding/encoding apparatuses and methods according to various embodiments, a depth image may be efficiently encoded or decoded, thereby lowering the complexity of the apparatuses and efficiently generating an image with synthesized viewpoints.

Meanwhile, technical solutions and effects of the inventive concept are not limited to the characteristics described above, one of ordinary skill in the art would appreciate other technical solutions that are not cited herein from the detailed descriptions below.

### DESCRIPTION OF THE DRAWINGS

FIG. 1A is a block diagram of an inter-layer video encoding apparatus according to an embodiment.

FIG. 1B is a flowchart of a video encoding method according to an embodiment.

FIG. 2A is a block diagram of an inter-layer decoding apparatus according to an embodiment.

FIG. 2B is a flowchart of a video decoding method according to an embodiment.

FIG. 3 is a diagram of an inter-layer prediction structure according to an embodiment.

FIG. 4 is a diagram of blocks that are referred to for predicting an intra prediction mode, according to an embodiment.

FIG. 5A is a flowchart of an operation of encoding residual data, by an inter-layer video encoding apparatus, according to a predetermined prediction mode, according to an embodiment.

FIG. 5B is a block diagram of an inter-layer video encoding apparatus according to an embodiment.

FIGS. 6A to 6D are diagrams of a method of encoding residual data, that is, residual components between a current block and a prediction block, by a video encoding apparatus according to an embodiment.

FIG. 7 is a block diagram of a video encoding apparatus based on coding units according to a tree structure, according to an embodiment.

FIG. 8 is a block diagram of a video decoding apparatus based on coding units according to a tree structure, according to various embodiments.

FIG. 9 is a diagram for describing a concept of coding units according to an embodiment.

FIG. 10 is a block diagram of an image encoder based on coding units, according to an embodiment.

FIG. 11 is a block diagram of an image decoder based on coding units, according to an embodiment.

FIG. 12 is a diagram illustrating deeper coding units and partitions, according to various embodiments.

FIG. 13 is a diagram for describing a relationship between a coding unit and transformation units, according to an embodiment.

FIG. 14 is a diagram for describing encoding information of deeper coding units, according to an embodiment.

FIG. 15 is a diagram of deeper coding units, according to an embodiment.

FIGS. 16 to 18 are diagrams for describing a relationship between coding units, prediction units, and transformation units, according to an embodiment.

FIG. 19 is a diagram for describing a relationship between a coding unit, a prediction unit, and a transformation unit, according to encoding mode information of Table 1.

FIG. 20 is a diagram of a physical structure of a disc in which a program is stored, according to various embodiments.

FIG. 21 is a diagram of a disc drive for recording and reading a program by using a disc.

FIG. 22 is a diagram of an overall structure of a content supply system for providing a content distribution service.

FIGS. 23 and 24 are diagrams of an external structure and an internal structure of a mobile phone to which a video encoding method and a video decoding method are applied, according to various embodiments.

FIG. 25 is a diagram of a digital broadcast system to which a communication system is applied, according to an embodiment.

FIG. 26 is a diagram illustrating a network structure of a cloud computing system using a video encoding apparatus and a video decoding apparatus, according to various embodiments.

### DESCRIPTION OF EMBODIMENT

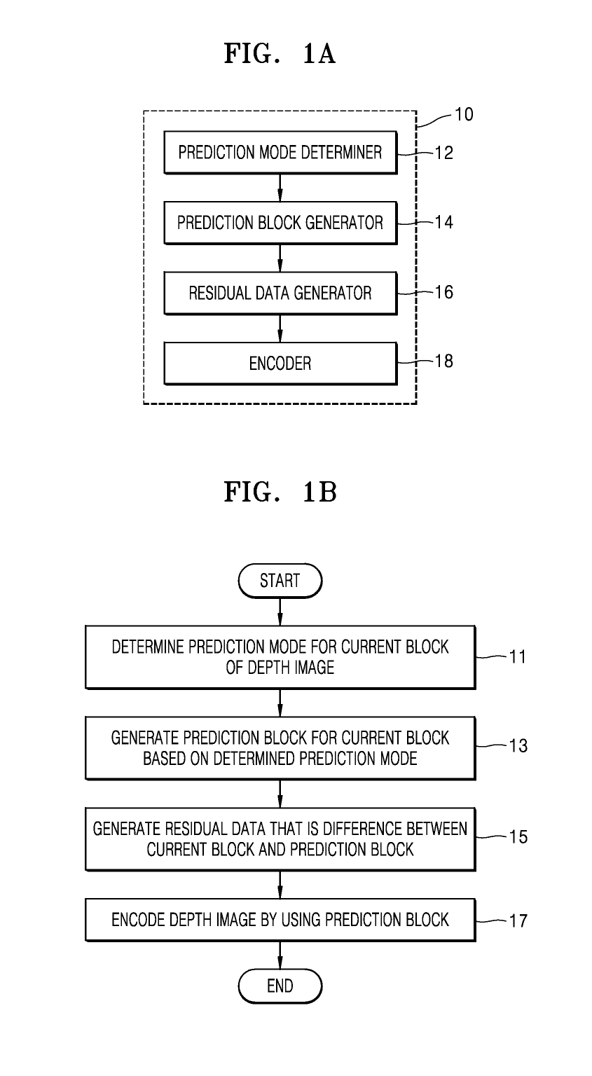

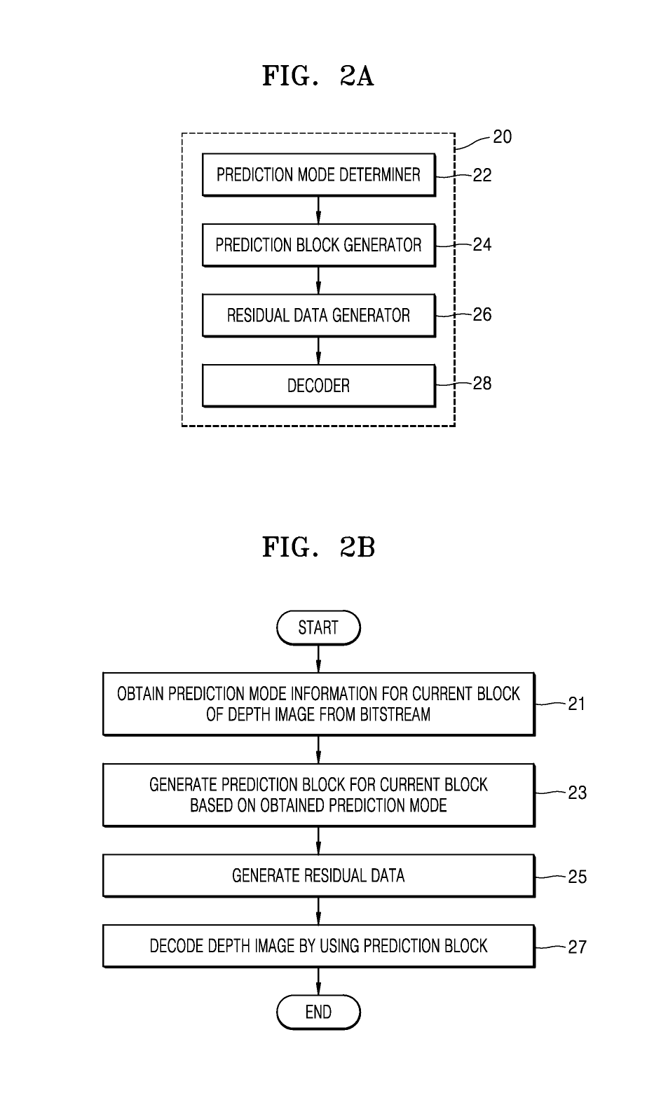

Hereinafter, a method of in-screen prediction of a depth image for methods and apparatuses for inter-layer video decoding and encoding according to one or more embodiments will be described below with reference to FIGS. 1A to 6D.

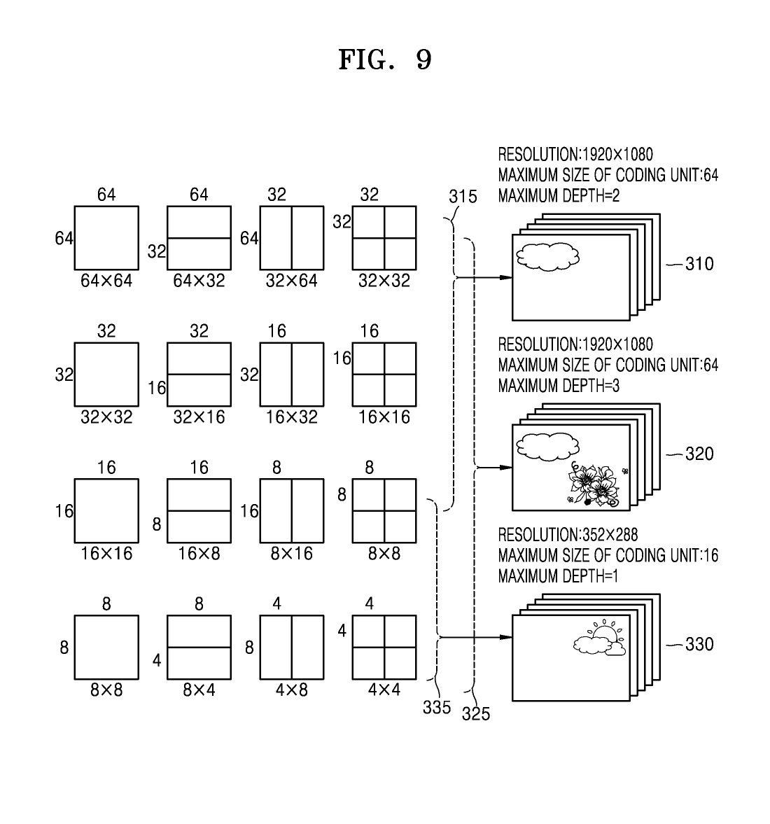

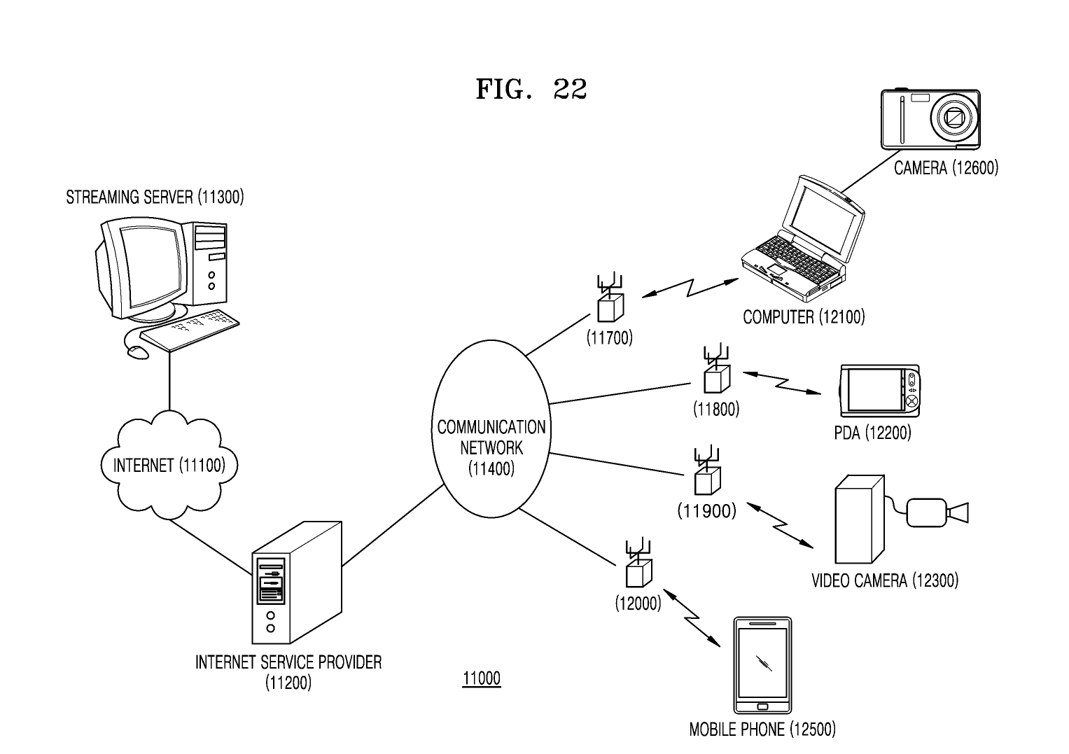

In addition, video encoding and decoding techniques based on coding units of a tree structure, which may be applied to the inter-layer video decoding and encoding techniques, will be described below with reference to FIGS. 7 to 19. Also, embodiments to which the video encoding and decoding methods suggested above may be applied will be described below with reference to FIGS. 21 to 27.

Hereinafter, an ‘image’ may denote a still image or a moving image of a video, or a video itself.

Hereinafter, a ‘sample’ that is data allocated to a sampling location of an image may mean data that is a processing target. For example, pixels in an image of a spatial area may be samples.

Hereinafter, a ‘current block’ may denote a block of a depth image to be encoded or decoded.

First, a method of in-screen prediction of a depth image for methods and apparatuses for inter-layer video decoding and encoding according to one or more embodiments, will be described with reference to FIGS. 1A to 6D.

FIG. 1A is a block diagram of an inter-layer video encoding apparatus 10 according to an embodiment. FIG. 1B is a flowchart of a video encoding method according to an embodiment.

The inter-layer video encoding apparatus 10 according to the embodiment may include a prediction mode determiner 12, a prediction block generator 14, a residual data generator 16, and an encoder 18. In addition, the inter-layer video encoding apparatus 10 according to the embodiment may include a central processor (not shown) that controls overall the prediction mode determiner 12, the prediction block generator 14, the residual data generator 16, and the encoder 18. Alternatively, each of the prediction mode determiner 12, the prediction block generator 14, the residual data generator 16, and the encoder 18 is operated by its own processor (not shown) and, as the processors (not shown) operate in a mutually organic relationship, the overall inter-layer video encoding apparatus 10 may be operated. Alternatively, the prediction mode determiner 12, the prediction block generator 14, the residual data generator 16, and the encoder 18 may be controlled by an external processor (not shown) outside the inter-layer video encoding apparatus 10.

The inter-layer video encoding apparatus 10 may include one or more data storage units (not shown) for storing data input to and output by the prediction mode determiner 12, the prediction block generator 14, the residual data generator 16, and the encoder 18. The inter-layer video encoding apparatus 10 may include a memory controller (not shown) for managing data input and output of the one or more data storage units (not shown).

In order to output a video encoding result, the inter-layer video encoding apparatus 10 may operate in conjunction with an internal video encoding processor embedded therein or an external video encoding processor, thereby performing a video encoding process including a transformation. The internal video encoding processor of the inter-layer video encoding apparatus 10 may be an individual processor and perform a video encoding process. Furthermore, the inter-layer video encoding apparatus 10, the central processor, or a graphic calculator may include a video encoding processing module, thereby performing a basic video encoding process.

The inter-layer video encoding apparatus 10 according to the embodiment may classify a plurality of image sequences according to layers and encode each of the image sequences according to a scalable video coding method, and output separate streams including data encoded according to layers. The inter-layer video encoding apparatus 10 may encode a first layer image sequence and a second layer image sequence to different layers.

For example, according to a scalable video coding method based on spatial scalability, low resolution images may be encoded as first layer images, and high resolution images may be encoded as second layer images. An encoding result of the first layer images is output as a first layer stream, and an encoding result of the second layer images is output as a second layer stream.

As another example, a multiview video may be encoded according to a scalable video coding method. In this case, central view images may be encoded as first layer images, and left view images and right view images may be encoded as second layer images referring to the first layer images. Alternatively, when the inter-layer video encoding apparatus 10 allows three or more layers, e.g., first through third layers, central view images may be encoded as first layer images, left view images may be encoded as second layer images, and right view images may be encoded as third layer images. However, one or more embodiments are not limited thereto, and layers and referred layers obtained by encoding central view, left view, and right view images may vary.

As another example, a scalable video coding method may be performed according to temporal hierarchical prediction based on temporal scalability. A first layer stream including encoding information generated by encoding base frame rate images may be output. Temporal levels may be classified according to frame rates and each temporal level may be encoded according to layers. A second layer stream including encoding information of a high frame rate may be output by further encoding high frame rate images by referring to the base frame rate images.

Also, scalable video coding may be performed on a first layer and a plurality of second layers. When there are three or more second layers, first layer images, first second layer images, second second layer images, . . . , K-th second layer images may be encoded. Accordingly, an encoding result of the first layer images may be output as a first layer stream, and encoding results of the first to K-th second layer images may be respectively output as first, second, . . . , K-th second layer streams.

The inter-layer video encoding apparatus 10 according to the embodiment may perform inter prediction a current image is predicted by referring to images of a single layer. By performing inter prediction, a motion vector indicating motion information between a current picture and a reference picture, and a residual component between the current picture and the reference picture may be generated.

Also, the inter-layer video encoding apparatus 10 may perform inter-layer prediction in which second layer images are predicted by referring to first layer images.

Also, when the inter-layer video encoding apparatus 10 according to the embodiment allows three or more layers, i.e., first to third layers, inter-layer prediction between a first layer image and a third layer image, and inter-layer prediction between a second layer image and a third layer image may be performed according to a multi-layer prediction structure.

Through the inter-layer prediction, a position difference component between a current picture and a reference picture of a layer different from that of the current picture and a residual component between the current picture and the reference picture of the different layer may be generated.

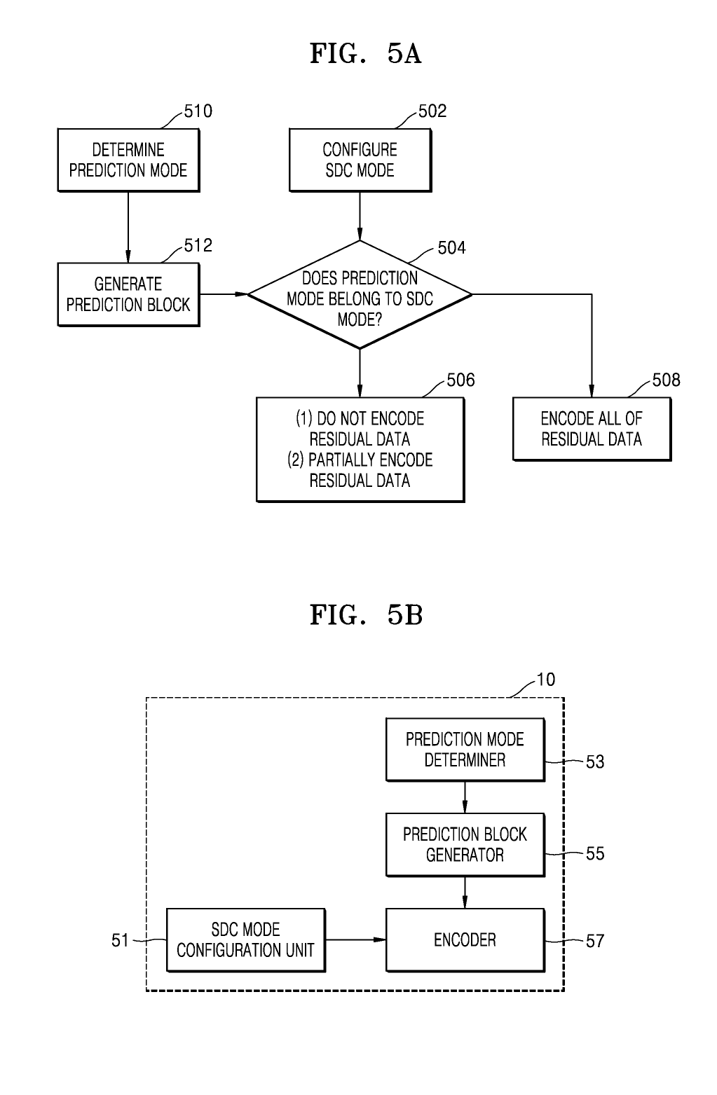

An inter-layer prediction structure will be described later with reference to FIG. 3.

The inter-layer video encoding apparatus 10 according to the embodiment may perform encoding according to blocks of each image of a video, according to layers. A block may have a square shape, a rectangular shape, or an arbitrary geometrical shape, and is not limited to a data unit having a certain size. The block may be a maximum coding unit, a coding unit, a prediction unit, or a transformation unit, among coding units according to a tree structure. A maximum coding unit including coding units of a tree structure may be named variously, such as a coding tree unit, a coding block tree, a block tree, a root block tree, a coding tree, a coding root, or a tree trunk. Video encoding and decoding methods based on coding units according to a tree structure will be described later with reference to FIGS. 7 through 19.

Meanwhile, if the inter-layer video encoding apparatus 10 according to the embodiment encodes a multiview video, the inter-layer video encoding apparatus 10 may additionally encode supplementary data, such as a depth image, and thus an image including more viewpoints than viewpoints input via a decoding end of an image may be generated. Here, since the depth image is used for synthesizing intermediate viewpoint images, rather than being directly displayed to a user, degradation of the depth image may affect the image quality of a synthesized image.

A depth value of a depth image is significantly changed nearby a boundary of an object and is relatively less significant inside the object. Therefore, minimization of errors occurring at the boundary of an object corresponding to significantly changing depth values may minimize errors of a synthesized image. Also, an efficiency of encoding a depth image may be improved by relatively reducing data amount with respect to the interior of an object in which a depth value is changed less significantly.

Therefore, the inter-layer video encoding apparatus 10 may encode a current block of a depth image by using a certain prediction mode (e.g., a DC mode, a planar mode, an angular mode, or a depth modeling mode (DMM) prediction mode). That is, the inter-layer video encoding apparatus 10 may generate a prediction block based on a predetermined prediction value, and generate a differential data between generated prediction block and a current block to be encoded, that is, residual data.

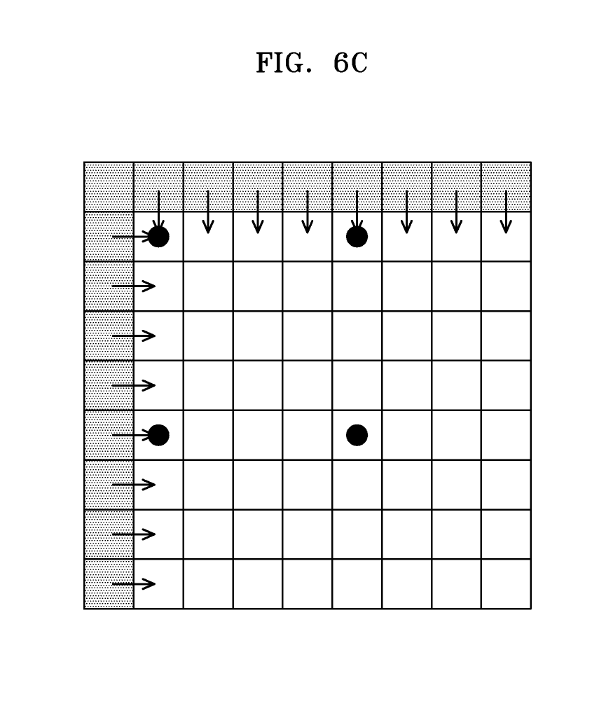

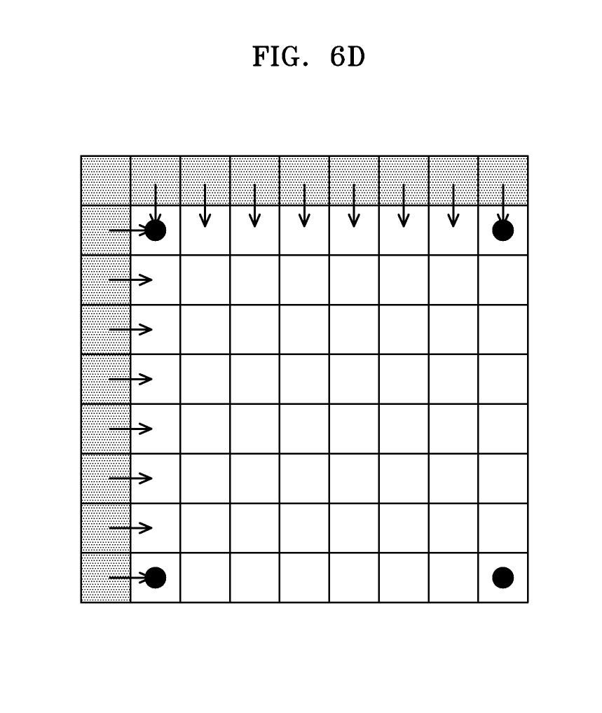

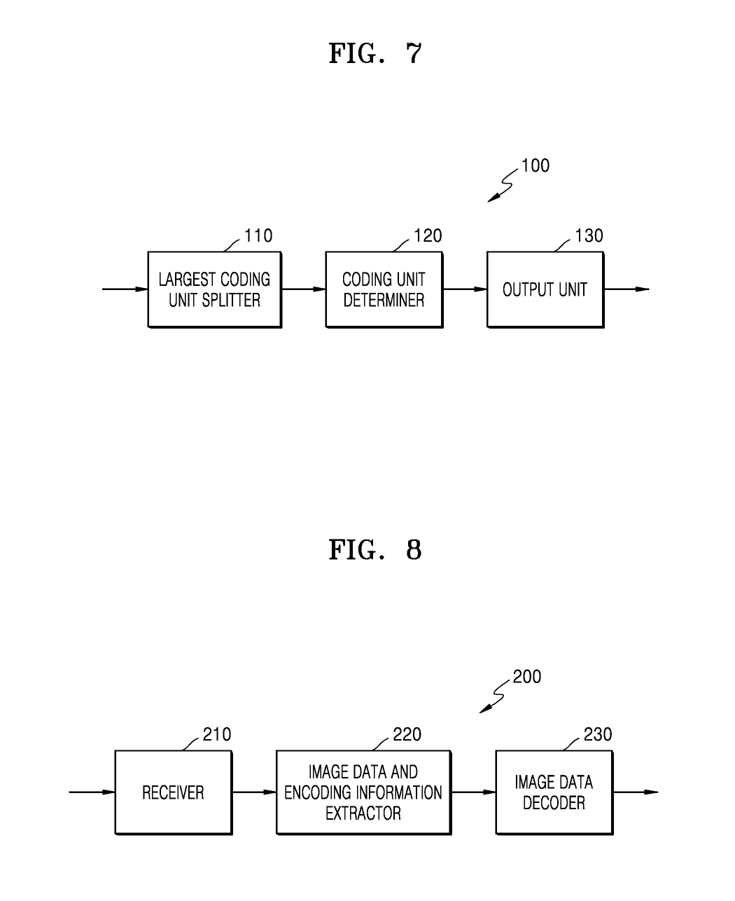

Residual data generated by using a predetermined prediction mode may not be encoded entirely, or only some of the residual data may be encoded. The inter-layer video encoding apparatus 10 according to the embodiment may encode an average value of the residual data, which will be described later with reference to FIGS. 5 and 6.

In addition, the inter-layer video encoding apparatus 10 may calculate a DC value (referred to hereinafter as an ‘average value’) with respect to a block to be encoded and map the calculated average value to a depth lookup table, thereby determining an index. Here, the depth lookup table refers to a table in which possible depth values of depth images are matched to indexes.

In addition, the inter-layer video encoding apparatus 10 may transmit only a difference between an index determined by mapping an average value for an original block to depth lookup table and an index calculated based on an average value obtained from a prediction block to a decoding apparatus. In this case, the difference between the indexes may be encoded.

Hereinafter, operations of the inter-layer video encoding apparatus 10 according to the embodiment will be described in detail with reference to FIG. 1B.

In operation 11, the prediction mode determiner 12 may determine a prediction mode for a current block of a depth image. Here, the prediction mode may be one of a DC mode, a planar mode, an angular mode, or a DMM prediction mode. Here, the DMM prediction mode may include a DMM mode-1 (or DMM_WFULL mode) and a DMM mode-4 (or DMM_CPREDTEX mode).

Here, the DC mode is an intra prediction mode for filling prediction samples of a prediction block with an average value of neighboring reference samples.

Furthermore, the planar mode is an intra prediction mode for calculating prediction samples predSample[x][y], with x,y=0 . . . nTbS−1 with respect to reference sample p[x][y] according to Equation 1 below.

predSamples[x][y]=((nTbS−1−x)*p[−1][y]+(x+1)*p[nTbS][−1]+(nTbS−1−y)*p[x][−1]+(y+1)*p[−1][nTbS]+nTbS)>>(Log 2(nTbS)+1) [Equation 1]

Here, nTbS denotes a horizontal length or a vertical length of a prediction block.

In addition, the angular mode refers to a prediction mode for determining a prediction sample from among reference samples in consideration of direction of in-screen prediction modes from mode 2 to mode 34.

Furthermore, the DMM prediction mode is a mode for performing predictions by dividing a current block into at least two areas according to a pattern, where an average value is calculated for each of the areas. Meanwhile, the DMM prediction mode may include a DMM mode-1 and a DMM mode-4. The DMM mode-1 may be a mode that the inter-layer video encoding apparatus 10 divides a current block by applying various boundaries and divides the current block based on the most appropriate boundary, whereas the DMM mode-4 may be a mode for dividing a prediction block into at least two or more blocks according to a pattern of the texture of the current block.

Meanwhile, the DC mode, the planar mode, the angular mode, and the depth modeling mode (DMM) prediction mode are modes for performing in-screen prediction by using reconstructed pixels around a current block and are obvious to one of ordinary skill in the art. Therefore, detailed descriptions thereof will be omitted.

In operation 13, the prediction block generator 14 may generate a prediction block for the current block based on the determined prediction mode.

In operation 15, the residual data generator 16 may generate residual data that is difference between the current block and the prediction block. The residual data generator 16 according to the embodiment may not transmit the residual data to the encoder 18, or averages entire or some of the residual data and transmit an average to the encoder 18.

For example, the residual data generator 16 may calculate an average value by using an upper left pixel value, an upper right pixel value, a lower left pixel value, and a lower right pixel value in a residual block that is a difference between the current block and the prediction block, and transmits the average value to the encoder 18. In detail, the residual data generator 16 may calculate a weighted sum of the upper left pixel value, the upper right pixel value, the lower left pixel value, and the lower right pixel value of the prediction block, rather than calculating the average value by using all pixel values in the residual block. In addition, one or more embodiments are not limited to the above example, that is, an average value of the residual block may be predicted by using at least one pixel value at each pixel location (e.g., four pixel values on an upper left portion and four pixel values on an upper right portion).

Alternatively, the residual data generator 16 may calculate the average value with respect to the residual block differently according to the prediction mode. For example, if the prediction block is predicted in the DC mode or the planar mode, the residual data generator 16 calculates the average value with respect to the residual block by using an average of the upper left pixel value, the upper right pixel value, the lower left pixel value, and the lower right pixel value in the residual block, and then, may transmit the average value to the encoder 18.

Alternatively, if the prediction block is predicted in the DMM mode, the residual data generator 16 may predict an average value according to each divided areas of the residual block by using the upper left pixel value, the upper right pixel value, the lower left pixel value, and the lower right pixel value.

As another example, the residual data generator 16 may predict an average value for a residual block by using pixel values at different locations according to prediction modes regarding the current block.

As another example, the residual data generator 16 may not transmit the residual data to the encoder 18, when the prediction block is predicted by using horizontal direction prediction mode or vertical direction prediction mode among the angular modes.

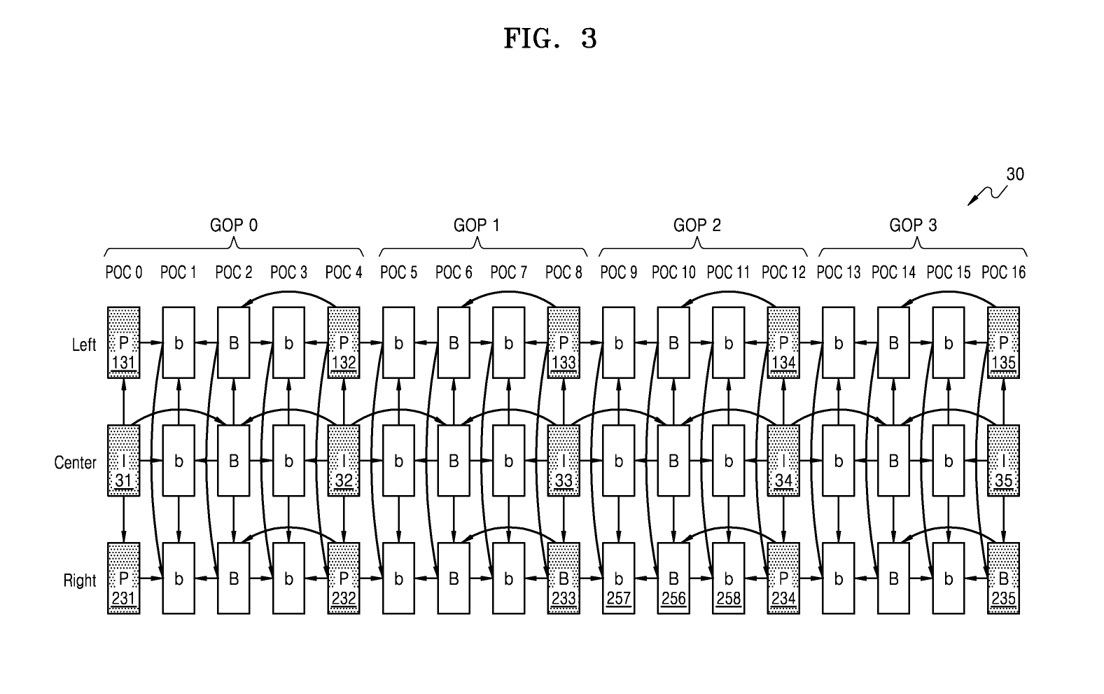

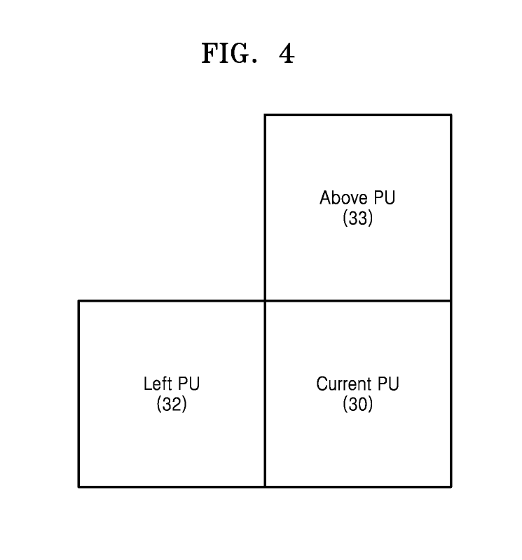

FIG. 2A is a block diagram of an inter-layer video decoding apparatus 20 according to an embodiment.

The inter-layer video decoding apparatus 20 according to the embodiment may include a parser 22, a prediction block generator 24, a residual data generator 26, and a decoder 28. Furthermore, the inter-layer video decoding apparatus 20 according to the embodiment may include a central processor (not shown) that controls the parser 22, the prediction block generator 24, the residual data generator 26, and the decoder 28. Alternatively, each of the parser 22, the prediction block generator 24, the residual data generator 26, and the decoder 28 is operated by its own processor (not shown) and, as the processors (not shown) operate in a mutually organic relationship, the overall inter-layer video decoding apparatus 20 may be operated. Alternatively, the parser 22, the prediction block generator 24, the residual data generator 26, and the decoder 28 may be controlled by an external processor (not shown) outside the inter-layer video decoding apparatus 20.

The inter-layer video decoding apparatus 20 may include one or more data storage units (not shown) for storing data input to and output by the parser 22, the prediction block generator 24, the residual data generator 26, and the decoder 28. The inter-layer video decoding apparatus 20 may include a memory controller (not shown) for managing data input and output of the one or more data storage units (not shown).

In order to reconstruct a video via video decoding, the inter-layer video decoding apparatus 20 according to the embodiment may operate in cooperation with an internal video decoding processor installed therein or an external video decoding processor so as to perform video decoding operations including inverse transformation. The internal video decoding processor of the inter-layer video decoding apparatus 20 according to the embodiment may be a separate processor, or alternatively, the inter-layer video decoding apparatus 20, a central processing apparatus, or a graphic processing apparatus may include a video decoding processing module to perform basic video decoding operations.

The inter-layer video decoding apparatus 20 according to the embodiment may receive bitstreams according to layers, via a scalable encoding method. The number of layers of bitstreams received by the inter-layer video decoding apparatus 20 is not limited.

For example, the inter-layer video decoding apparatus 20 based on spatial scalability may receive a stream in which image sequences having different resolutions are encoded in different layers. A first layer stream may be decoded to reconstruct an image sequence having low resolution and a second layer stream may be decoded to reconstruct an image sequence having high resolution.

As another example, a multiview video may be decoded according to a scalable video coding method. When a stereoscopic video stream is received in a plurality of layers, a first layer stream may be decoded to reconstruct left view images. A second layer stream may be further decoded to reconstruct right view images.

Alternatively, when a multiview video stream is received in a plurality of layers, a first layer stream may be decoded to reconstruct central view images. A second layer stream may be further decoded to reconstruct left view images, in addition to the first layer stream. A third layer stream may be further decoded to reconstruct right view images, in addition to the first layer stream.

As another example, a scalable video coding method based on temporal scalability may be performed. A first layer stream may be decoded to reconstruct base frame rate images. A second layer stream may be further decoded to reconstruct high frame rate images, in addition to the first layer stream.

Also, when there are at least three second layers, first layer images may be reconstructed from a first layer stream, and when a second layer stream is further decoded by referring to first layer reconstruction images, second layer images may be further reconstructed. When K-th layer stream is further decoded by referring to second layer reconstruction images, K-th layer images may be further reconstructed.

The inter-layer video decoding apparatus 20 may obtain encoded data of first layer images and second layer images from a first layer stream and a second layer stream, and in addition, may further obtain a motion vector generated via inter prediction and prediction information generated via inter-layer prediction.

For example, the inter-layer video decoding apparatus 20 may decode inter-predicted data per layer, and decode inter-layer predicted data between a plurality of layers. Reconstruction may be performed through motion compensation and inter-layer decoding based on a coding unit or a prediction unit.

Images may be reconstructed by performing motion compensation for a current picture by referring to reconstruction images predicted via inter prediction of a same layer, with respect to each layer stream. Motion compensation is an operation in which a reconstruction image of a current picture is reconstructed by synthesizing a reference picture determined by using a motion vector of the current picture and a residual component of the current picture.

Also, the inter-layer video decoding apparatus 20 may perform inter-layer decoding by referring to prediction information of first layer images so as to decode a second layer image predicted via inter-layer prediction. Inter-layer decoding is an operation in which prediction information of a current picture is reconstructed by using prediction information of a reference block of a different layer so as to determine the prediction information of the current picture.

The inter-layer video decoding apparatus 20 according to the embodiment may perform inter-layer decoding for reconstructing third layer images predicted by referring to second layer images. An inter-layer prediction structure will be described later with reference to FIG. 3.

The inter-layer video decoding apparatus 20 performs decoding according to blocks of each image of a video. A block may be, from among coding units according to a tree structure, a maximum coding unit, a coding unit, a prediction unit, or a transformation unit. Methods of encoding and decoding based on coding units according to a tree structure will be described below with reference to FIGS. 7 to 19.

Meanwhile, if the inter-layer video encoding apparatus 10 according to the embodiment encodes a multiview video, the inter-layer video encoding apparatus 10 may additionally encode supplementary data, such as a depth image, and thus an image including more viewpoints than viewpoints input via a decoder may be generated. Here, since the depth image is used for synthesizing intermediate viewpoint images instead of being directly displayed to a user, degradation of the depth image may affect the quality of a synthesized image.

A depth value of a depth image is significantly changed nearby a boundary of an object and is less significant inside the object. Therefore, minimization of errors occurring at the boundary of an object corresponding to significantly changing depth values may minimize errors of a synthesized image. Furthermore, an efficiency of encoding a depth image may be improved by relatively reducing data amount with respect to the interior of an object in which a depth value is changed less significantly.

Therefore, in order to decode a depth image, the inter-layer video decoding apparatus 20 may generate a prediction block by using a certain prediction mode (e.g., a DC mode, a planar mode, an angular mode, or a DMM prediction mode). Also, the inter-layer video decoding apparatus 20 may receive differential data between generated prediction block and a current block to be encoded, that is, residual data, from a bitstream.

Otherwise, the inter-layer video decoding apparatus 20 may calculate a DC value (referred to hereinafter as an ‘average value’) with respect to a prediction block and map the calculated average value to a depth lookup table, thereby determining an index. Furthermore, the inter-layer video decoding apparatus 20 may receive a difference between an index corresponding to an average value for a restored block and an index corresponding to an average value for the prediction block via a bitstream.

Hereinafter, operations of the inter-layer video decoding apparatus 20 according to the embodiment will be described in detail with reference to FIG. 2B.

In operation 21, the parser 22 may obtain prediction mode information regarding a current block of a depth image from a bitstream. Here, the prediction mode information may represent which one of the DC mode, the planar mode, the angular mode, and the DMM mode is used to predict the current block. Here, the DMM prediction mode may include a DMM mode-1 (or DMM_WFULL mode) and a DMM mode-4 (or DMM_CPREDTEX mode).

In operation 21, the parser 22 may parse a flag representing whether the prediction mode for the current block is a simplified depth coding (SDC) mode that will be described later.

In operation 23, the prediction block generator 24 may generate a prediction block for the current block based on the obtained prediction mode information.

In operation 25, the residual data generator 26 may obtain residual data from a bitstream. However, under a certain prediction mode, the residual data may not be decoded.

In operation 27, the decoder 28 may decode the depth image by using the prediction block.

Hereinafter, an inter-layer prediction structure that may be performed in the inter-layer video encoding apparatus 10 according to an embodiment will be described with reference to FIG. 3.

FIG. 3 is a diagram of an inter-layer prediction structure according to the embodiment.

The inter-layer video encoding apparatus 10 according to the embodiment may prediction-encode base view images, left view images, and right view images according to a reproduction order 30 of a multiview video prediction structure of FIG. 3.

According to the reproduction order 30 of the multiview video prediction structure according to a related technology, images of the same view are arranged in a horizontal direction. According to the reproduction order 30, the left view images indicated by ‘Left’ are arranged in the horizontal direction in a row, the base view images indicated by ‘Center’ are arranged in the horizontal direction in a row, and the right view images indicated by ‘Right’ are arranged in the horizontal direction in a row. Compared to the left/right view images, the base view images may be central view images.

Also, images having the same picture order count (POC) order are arranged in a vertical direction. A POC order of images indicates a reproduction order of images forming a video. ‘POC X’ indicated in the reproduction order 30 of the multiview video prediction structure indicates a relative reproduction order of images in a corresponding column, wherein a reproduction order is in front when a value of X is low, and is behind when the value of X is high.

Thus, according to the reproduction order 30 of the multiview video prediction structure according to the related technology, the left view images indicated by ‘Left’ are arranged in the horizontal direction according to the POC order (reproduction order), the base view images indicated by ‘Center’ are arranged in the horizontal direction according to the POC order (reproduction order), and the right view images indicated by ‘Right’ are arranged in the horizontal direction according to the POC order (reproduction order). Also, the left view image and the right view image located on the same column as the base view image have different views but the same POC order (reproduction order).

Four consecutive images form one group of pictures (GOP) according to views. Each GOP includes images between consecutive anchor pictures, and one anchor picture (key picture).

An anchor picture is a random access point, and when a reproduction location is arbitrarily selected from images arranged according to a reproduction order, i.e., a POC order, while reproducing a video, an anchor picture closest to the reproduction location according to the POC order is reproduced. The base view images include base view anchor pictures 31 to 35, the left view images include left view anchor pictures 131 to 135, and the right view images include right view anchor pictures 231 to 235.

Multiview images may be reproduced and predicted (reconstructed) according to a GOP order. First, according to the reproduction order 30 of the multiview video prediction structure, images included in GOP 0 may be reproduced, and then images included in GOP 1 may be reproduced, according to views. In other words, images included in each GOP may be reproduced in an order of GOP 0, GOP 1, GOP 2, and GOP 3. Also, according to a coding order of the multiview video prediction structure, the images included in GOP 1 may be predicted (reconstructed), and then the images included in GOP 1 may be predicted (reconstructed), according to views. In other words, the images included in each GOP may be predicted (reconstructed) in an order of GOP 0, GOP 1, GOP 2, and GOP 3.

According to the reproduction order 30 of the multiview video prediction structure, inter-view prediction (inter-layer prediction) and inter prediction are performed on images. In the multiview video prediction structure, an image where an arrow starts is a reference picture, and an image where an arrow ends is an image predicted by using a reference picture.

A prediction result of base view images may be encoded and then output in a form of a base view image stream, and a prediction result of additional view images may be encoded and then output in a form of a layer bitstream. Also, a prediction encoding result of left view images may be output as a first layer bitstream, and a prediction encoding result of right view images may be output as a second layer bitstream.

Only inter-prediction is performed on base view images. In other words, the base layer anchor pictures 31 through 35 of an I-picture type do not refer to other images, but remaining images of B- and b-picture types are predicted by referring to other base view images. Images of a B-picture type are predicted by referring to an anchor picture of an I-picture type, which precedes the images of a B-picture type according to a POC order, and a following anchor picture of an I-picture type. Images of a b-picture type are predicted by referring to an anchor picture of an I-type, which precedes the image of a b-picture type according a POC order, and a following image of a B-picture type, or by referring to an image of a B-picture type, which precedes the images of a b-picture type according to a POC order, and a following anchor picture of an I-picture type.

Inter-view prediction (inter-layer prediction) that refers to different view images, and inter prediction that references same view images are performed on each of left view images and right view images.

Inter-view prediction (inter-layer prediction) may be performed on the left view anchor pictures 131 to 135 by respectively referring to the base view anchor pictures 31 to 35 having the same POC order. Inter-view prediction may be performed on the right view anchor pictures 231 to 235 by respectively referring to the base view anchor pictures 31 to 35 or the left view anchor pictures 131 to 135 having the same POC order. Also, inter-view prediction (inter-layer prediction) may be performed on remaining images other than the left view images 131 to 135 and the right view images 231 to 235 by referring to other view images having the same POC order.

Remaining images other than the anchor pictures 131 to 135 and 231 to 235 from among left view images and right view images are predicted by referring to the same view images.

However, each of the left view images and the right view images may not be predicted by referring to an anchor picture that has a preceding reproduction order from among additional view images of the same view. In other words, in order to perform inter prediction on a current left view image, left view images excluding a left view anchor picture that precedes the current left view image in a reproduction order may be referenced. Similarly, in order to perform inter prediction on a current right view image, right view images excluding a right view anchor picture that precedes the current right view image in a reproduction order may be referenced.

Also, in order to perform inter prediction on a current left view image, prediction may be performed by referring to a left view image that belongs to a current GOP but is to be reconstructed before the current left view image, instead of referring to a left view image that belongs to a GOP before the current GOP of the current left view image. The same is applied to a right view image.

The inter-layer video decoding apparatus 20 according to the embodiment may reconstruct base view images, left view images, and right view images according to the reproduction order 30 of the multiview video prediction structure of FIG. 3.

Left view images may be reconstructed via inter-view disparity compensation that refers to base view images and inter motion compensation that refers to left view images. Right view images may be reconstructed via inter-view disparity compensation that refers to base view images and left view images, and inter motion compensation that refers to right view images. Reference pictures may be reconstructed first for disparity compensation and motion compensation of left view images and right view images.

For inter motion compensation of a left view image, left view images may be reconstructed via inter motion compensation that refers to a reconstructed left view reference picture. For inter motion compensation of a right view image, right view images may be reconstructed via inter motion compensation that refers to a reconstructed right view reference picture.

Also, for inter motion compensation of a current left view image, only a left view image that belongs to a current GOP of the current left view image but is to be reconstructed before the current left view image may be referenced, and a left view image that belongs to a GOP before the current GOP is not referenced. The same is applied to a right view image.

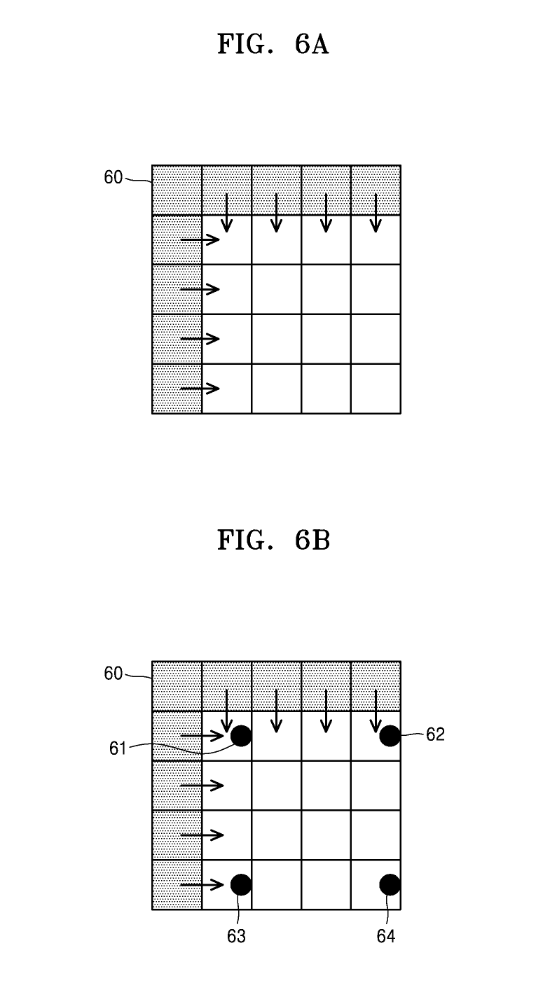

Hereinafter, a method of in-screen prediction of a depth image for methods and apparatus for encoding and decoding inter-layer video according to an embodiment will be described in detail with reference to FIGS. 4 to 6.

FIG. 4 is a diagram of blocks that are referred to in order to predict an intra prediction mode, according to an embodiment.

Prediction units (PU) are exemplarily shown as blocks. The PU is a data unit for performing a prediction of each coding unit in a video encoding technique based on coding units according to a tree structure. The video encoding apparatus 10 and the video decoding apparatus 20 according to the embodiment may perform predictions on prediction units of various sizes, not being limited to a prediction unit of a fixed size. The video encoding method and the prediction unit based on the coding units of a tree structure will be described in detail later with reference to FIGS. 7 to 19. Hereinafter, although an embodiment is described with respect to the prediction of the intra prediction mode with respect to the PU, the embodiment may be similarly applied to various kinds of blocks.

The video encoding apparatus 10 according to the embodiment may refer to intra prediction modes of a left PU 32 and an upper PU 33, in order to predict an intra prediction mode of a current PU 30. This uses a statistical characteristic of the images and the in-screen prediction mode, that is, when a natural image is divided into blocks of constant sizes, a current block and peripheral blocks generally have similar image characteristics, and thus are likely to have the same or similar in-screen prediction modes.

The video encoding apparatus 10 according to the embodiment may determine intra prediction modes of the left PU 32 and the upper PU 33 of the current PU 30 as most probable mode (MPM). In addition, the video encoding apparatus 10 may determine whether there is the same mode as the current intra prediction mode of the current PU 30, and set an MPM flag.

For example, if the intra prediction modes of the left PU 32 and the upper PU 33 are different from the current intra prediction mode, an MPM flag is encoded as ‘0’, and if at least one of the intra prediction modes of the left PU 32 and the upper PU 33 is the same as the current intra prediction mode, the MPM flag may be encoded as ‘1’.

Hereinafter, for convenience of description, the intra prediction mode of the left (upper) PU 32 or 33 may be referred to as a left (upper) intra prediction mode.

When the left/upper intra prediction modes and the current intra prediction mode are different from each other, current intra mode information representing the current intra prediction mode may be encoded.

When at least one of the left/upper intra prediction modes is the same as the current intra prediction mode, two or more candidate intra prediction modes may be determined for predicting the current intra prediction mode. The candidate intra prediction modes may be intra prediction modes that are highly probable to be predicted as the current intra prediction mode.

Two candidate intra prediction modes may be a left intra prediction mode and an upper intra prediction mode.
<MPM determination equation 1>
MPM0=min(leftIntraMode, aboveInftraMode);
MPM1=max(leftIntraMode, aboveInftraMode);

In the MPM determination equation 1, MPM0 and MPM1 respectively denote first rank and second rank candidate intra prediction modes. min(A, B) is a function of outputting a smaller value between A and B, and max(A, B) is a function of outputting remaining bigger value.

In the MPM determination equation 1, leftIntraMode and aboveInftraMode respectively denote an index of the left intra prediction mode and an index of the upper intra prediction mode. A smaller index is aligned to an intra prediction mode having a higher probability or an intra prediction mode that has to be adopted with priority.

That is, according to the MPM determination equation 1, the index of the left intra prediction mode and the index of the upper intra prediction mode are mapped to the first rank and second rank candidate intra prediction modes in an order of smaller index, and then may be adopted as the candidate intra prediction modes in an order of high probability or adoption priority.

This is applied similarly to the video decoding apparatus 20. The MPM flag is parsed from the bitstream. Then, when the left/upper intra prediction modes are different from the current intra prediction mode, the current intra mode information representing the current intra prediction mode is parsed from the bitstream, and when one of the left/upper intra prediction modes is the same as the current intra prediction mode, two or more different candidate intra prediction modes may be determined in order to predict the current intra prediction mode.

However, when the left intra prediction mode and the upper intra prediction mode are the same as each other, a plurality of candidate intra prediction modes that are different from each other are not determined yet even if the left/upper intra prediction modes are adopted as the candidate intra prediction modes.

Hereinafter, determination of a plurality of candidate intra prediction modes that are different from each other when one of the left intra prediction mode and the upper intra prediction mode is the same as the current intra prediction mode and the left intra prediction mode and the upper intra prediction mode are the same as each other, will be described below according to one or more embodiments.

1. A plurality of candidate intra prediction modes may include default intra prediction modes that are different from each other. As the default intra prediction mode according to the embodiment, an intra prediction mode having higher probability, an intra prediction mode having an excellent prediction performance, a mode approximate to the left intra prediction mode, etc. may be adopted. The prediction mode having the high probability or having excellent prediction performance may include a DC prediction mode, a planar mode, a vertical mode, etc.

Among the intra prediction mode, when the intra prediction is performed in the planar mode, luminance of pixels in a PU has a gradation type, and may be predicted to be gradually bright or gradually dark according to a certain direction.

For example, when the left intra prediction mode is the DC prediction mode or the planar mode, three candidate intra prediction modes may be determined as default intra prediction modes, e.g., the DC prediction mode, the planar mode, and the vertical mode.

2. The plurality of candidate intra prediction modes may include the left intra prediction mode and a default intra prediction mode.
<MPM determination equation 2>
if(leftIntraMode==aboveIntraMode==DC)
   aboveIntramode=Planar mode {or 0 if no planar mode}
else
   aboveIntraMode=DC

According to the MPM determination equation 2, after determining the left prediction mode and the upper intra prediction mode, candidate intra prediction modes may be determined according to the MPM determination equation 1.

According to the MPM determination equation 2, when both the left intra prediction mode and the upper intra prediction mode are DC prediction modes, the upper intra prediction mode may be changed to a planar mode (or an intra prediction mode having an index of 0). In this case, the candidate intra prediction modes may include the DC prediction mode that is the left intra prediction mode or the planar mode (or the intra prediction mode having an index of 0), according to the MPM determination equation 1.

In addition, according to the MPM determination equation 2, when at least one of the upper intra prediction mode and the upper intra prediction mode is not the DC prediction mode, the upper intra prediction mode may be changed to the DC prediction mode. In this case, the candidate intra prediction modes may include the left intra prediction mode or the DC prediction mode according to the MPM determination equation 1.

3. The plurality of candidate intra prediction modes may be determined as values by using or deforming the left intra prediction mode.

For example, when the left intra prediction mode is an intra prediction mode in a certain direction, the candidate intra prediction modes may include the left intra prediction mode and an intra prediction mode corresponding to an index that has increased or reduced as much as a predetermined offset from the index representing the left intra prediction mode.
<MPM determination equation 3>
MPM0=leftIntraMode;
MPM1=leftIntraMode−n;
MPM2=leftIntraMode+n;

According to the MPM determination equation 3, a first rank candidate intra prediction mode may be determined as the left intra prediction mode, a second rank candidate intra prediction mode may be determined as a mode having an index that is smaller than that of the left intra prediction mode by n, and a third rank candidate intra prediction mode may be determined as a mode having an index that is greater than that of the left intra prediction mode by n. Here, n may be an integer, e.g., 1, 2, etc.

4. The plurality of candidate intra prediction modes may be determined by using a lookup table that represents relationships between the value of the left intra prediction mode and candidate intra prediction modes corresponding to the left intra prediction mode. That is, based on the lookup table, a plurality of candidate intra prediction modes mapping to the current left intra prediction mode may be selected. In the above examples 1, 2, and 3, the candidate intra prediction modes are determined according to the left intra prediction mode, and thus, the results may be similar to that of the lookup table mapping method according to the left intra prediction mode.

5. The lookup table of the candidate intra prediction modes includes the left intra prediction mode as a first rank, and intra prediction modes as a second rank, and so on, in order of the statistical probability.

6. An occurrence frequency or statistical probability is determined with respect to each of the intra prediction modes that are previously encoded (decoded), and the intra prediction modes having the highest statistical probability may be adopted as the candidate intra prediction modes.

7. When an intra prediction mode that is different from the intra prediction modes of the left and upper PUs is detected from among neighboring PUs, except the left and upper PUs, the candidate intra prediction modes may include the left (upper) intra prediction mode and detected intra prediction mode of the neighboring PU.

FIG. 5A is a flowchart of an operation of encoding residual data according to a predetermined prediction mode, by an inter-layer video encoding apparatus, according to an embodiment.

As described above, the inter-layer video encoding apparatus 10 may generate prediction blocks by using a predetermined prediction mode (e.g., a DC mode, a planar mode, an angular mode, and a DMM mode) in order to encode a depth image.

The inter-layer video encoding apparatus 10 according to the embodiment may configure some of the predetermined prediction mode as an SDC mode. The SDC mode is a mode for effectively encoding a depth image having a lot of flat portions, unlike a color image, and the inter-layer encoding apparatus 10 may configure a predetermined prediction mode as the SDC mode. Also, the inter-layer encoding apparatus 10 may improve an encoding efficiency of a depth image without encoding residual data between a prediction block generated in the prediction mode included in the SDC mode and the current block, or by only encoding some of the residual data.

In operation 502, the inter-layer video encoding apparatus 10 according to the embodiment may configure one or more depth intra modes as an SDC mode. For example, the inter-layer video encoding apparatus 10 may configure a planar mode as the SDC mode. Alternatively, the inter-layer video encoding apparatus 10 may configure the planar mode and a DMM1 mode as the SDC modes. The inter-layer video encoding apparatus 10 according to the different embodiment may configure horizontal direction prediction mode and vertical direction prediction mode as the SDC modes.

In operation 502, the inter-layer video encoding apparatus 10 may select some of MPM modes described above with reference to FIG. 4 and configure selected modes as the SDC modes. In this case, when the prediction modes of the peripheral blocks are not intra modes, an arbitrary intra mode such as planar mode may be used. For example, the inter-layer video encoding apparatus 10 may only configure a first rank candidate intra prediction mode, that is, MPM mode, as the SDC mode. Alternatively, the inter-layer video encoding apparatus 10 may configure one or more modes among the MPM modes as the SDC modes.

In operation 502, the inter-layer video encoding apparatus 10 according to the embodiment may configure some of the intra mode and the MPM modes as the SDC modes. For example, the SDC mode may be configured by using one intra mode (planer mode or DMM1 mode) and a first MPM mode. Otherwise, the SDC mode may be configured by using one or more depth intra modes and one or more MPM modes.

In operation 502, the inter-layer video encoding apparatus 10 according to the embodiment may configure the SDC mode that varies depending on sizes of coding units or prediction units. That is, the SDC modes may be differently configured by using one or more intra modes and one or more MPM modes based on the sizes of the coding units or the prediction units. The inter-layer video encoding apparatus 10 according to the different embodiment may not configure the SDC modes according to sizes of coding units or prediction units. That is, the SDC modes may not be configured when the size of coding units or prediction units is specific value.

For example, the inter-layer video encoding apparatus 10 may configure the SDC mode as {MPM1, MPM2, MPM3} when a size of the coding unit is 64×64 or greater. MPM1, MPM2, and MPM3 respectively denote a first rank candidate intra prediction mode, a second rank candidate intra prediction mode, and a third rank candidate intra prediction mode. The inter-layer video encoding apparatus 10 according to the embodiment may configure the SDC mode as {MPM1, MPM2, DMM1} when a size of the coding unit is less than 32×32. That is, when the size of the coding unit is sufficiently small, an encoding efficiency may degrade in a case where the prediction block is generated in the MPM3. Thus, the SDC mode may be configured by using DMM1, instead of MPM3.

The inter-layer video encoding apparatus 10 according to the different embodiment may not configure the SDC mode when a size of the coding unit is greater than or equal to 64×64. The inter-layer video encoding apparatus 10 according to the embodiment may configure all of the intra prediction modes as the SDC mode when a size of the coding unit is smaller than 32×32.

In operation 502, the inter-layer video encoding apparatus 10 according to the embodiment may record a flag representing which intra prediction mode corresponds to the SDC mode on the bitstream.

In operation 504, the inter-layer video encoding apparatus 10 may determine whether the prediction mode of the current block corresponds to the SDC mode. When the prediction mode corresponds to the SDC mode, the process goes to operation 506, and when the prediction mode does not correspond to the SDC mode, the process goes to operation 508.

In operation 510, the inter-layer video encoding apparatus 10 may determine a prediction mode of the current block in a depth image. Here, the prediction mode may be one of a DC mode, a planar mode, an angular mode, and a DMM mode. The DMM mode may include a DMM mode-1 (or DMM_WFULL mode) and a DMM mode-4 (or DMM_CPREDTEX mode).

In operation 512, the inter-layer video encoding apparatus 10 may generate a prediction block of the current block, based on determined prediction mode.

In operation 506, when the prediction mode of the current block corresponds to the SDC mode, the inter-layer video encoding apparatus 10 may not encode or partially encode residual data to generate a bitstream, wherein the residual data is residual component between a prediction block generated in determined prediction mode and the current prediction mode. This will be described later with reference to FIG. 6.

In operation 508, the inter-layer video encoding apparatus 10 may encode all of the residual data to generate a bitstream.

FIG. 5B is a block diagram of the inter-layer video encoding apparatus according to the embodiment.

FIG. 5B shows a block diagram of the inter-layer video encoding apparatus executing operations of the flowchart of FIG. 5A, according to the embodiment. Therefore, descriptions provided above with respect to the inter-layer encoding method illustrated with reference to FIG. 5A may be applied to the inter-layer encoding apparatus 10 of FIG. 5B.

A prediction mode determiner 53 may determine a prediction mode of a current block in a depth image. Here, the prediction mode may be one of a DC mode, a planar mode, an angular mode, and a DMM mode. The DMM mode may include DMM mode-1 (or DMM_WFULL mode) and DMM mode-4 (or DMM_CPREDTEX mode).

A prediction block generator 55 may generate a prediction block of the current block, based on determined prediction mode.

An SDC mode configure unit 51 may configure some of predetermined prediction modes as the SDC mode.

When the prediction mode of the current block corresponds to the SDC mode, an encoder 57 may not encode or partially encode the residual data that is the residual component between the prediction block generated in determined prediction mode and the current prediction mode.

FIG. 6A is a diagram for describing a method of encoding residual data that is residual component between a current block and a prediction block, by an inter-layer video encoding apparatus 10 according to an embodiment.

When a prediction mode of a current block corresponds to an SDC mode, the inter-layer video encoding apparatus 10 according to the embodiment may not encode residual data that is a residual component between a prediction block generated in the SDC mode and the current block. The inter-layer video encoding apparatus 10 according to the embodiment may generate a prediction block by using a pixel value of only one of peripheral pixels that are adjacent to the current block, and may not encode the residual data. The inter-layer video encoding apparatus 10 may generate the prediction block only by using a certain pixel, and may insert a flag representing that the residual data is not encoded into the bitstream. In a case where the residual data is not encoded, the video encoding apparatus 10 may operate similarly to a skip mode in an inter mode.

FIG. 6B is a diagram for describing a method of encoding residual data that is a residual component between a current block and a prediction block, by a video encoding apparatus according to an embodiment.

When the prediction mode of the current block corresponds to the SDC mode, the inter-layer video encoding apparatus 10 according to the embodiment may encode only a part of the residual data.

FIG. 6B shows a residual block between the current block and the prediction block. The inter-layer video encoding apparatus 10 may predict an average value for the residual block by using a pixel value at a predetermined location in the residual block.

For example, the inter-layer video encoding apparatus 10 may predict an average value of an upper left pixel value 61, an upper right pixel value 62, a lower left pixel value 63, and a lower right pixel value 64 in a 4×4 residual block 60, as an average value for the residual block 60. As another example, the average value of the residual block 60 may be predicted by using a weighted sum as expressed by Equation 2 below.

dc=(α₁·P_{left-top}+α₂·P_{right-top}+α₃·P_{left-bottom}+α₄·P_{right-bottom}+β)>>γ [Equation 2]

Here, dc denotes an average value of the residual block, P respectively denotes the upper left pixel value 61, the upper right pixel value 62, the lower left pixel value 63, and the lower right pixel value 64, and α, β, and γ denote variables for calculating a weighted sum.

Meanwhile, the embodiment only provides the method of calculating an average of the residual block 60 having a 4×4 size, but the method may be identically applied to blocks of 8×8, 16×16, 32×32, and 64×64, and also applied to processes of encoding the residual data by calculating average values of the prediction block and the current block and calculating a difference between the average values.

Meanwhile, the embodiment of FIG. 6B provides an example in which the average value is calculated by using four pixel values at corners of the residual block 60, but one or more embodiments are not limited thereto, that is, the average value may be calculated by using pixel values at four corners and a center portion of the block.

FIGS. 6C and 6D are diagrams for describing a method of encoding residual data differently according to the prediction mode or sizes of the coding units and the prediction units.

As described above, when encoding residual data, the inter-layer video encoding apparatus 10 may calculate an average of a residual block, and in this case, locations of pixels that are used to calculate the average for the residual block may be vary depending on at least one of the prediction mode, and size of the coding unit or the prediction unit.

For example, as shown in FIG. 6C, when a size of the coding unit is 64×64 and the prediction mode of the current block is MPM, the inter-layer video encoding apparatus 10 may perform a sampling operation at every fourth pixel in a horizontal direction or a vertical direction of the residual block, and then, calculate an average value only by using sampled pixels 651, 652, 653, and 654 to encode the residual data.

Also, for example, when a size of the coding unit is 32×32 (660) and the prediction mode of the current block is DMM, the inter-layer video encoding apparatus 10 may calculate an average value only by using pixels 661, 662, 663, and 664 located at four corners to encode the residual data.

Meanwhile, for convenience of description, FIGS. 5A to 6D only provide operations performed by the inter-layer video encoding apparatus 10 and omit operations performed by the inter-layer video decoding apparatus 20, but one of ordinary skill in the art would appreciate that the inter-layer video decoding apparatus 20 may perform operations corresponding to the above operations.

As described above, in the inter-layer video encoding apparatus 10 according to various embodiments and the inter-layer video decoding apparatus 20 according to various embodiments, blocks divided from video data are split into coding units of a tree structure, and the coding units, prediction units, and transformation units may be used for performing an inter-layer prediction or an inter prediction on the coding units. Hereinafter, a video encoding method and apparatus and a video decoding method and apparatus based on coding units having a tree structure and transformation units, according to various embodiments, will be described below with reference to FIGS. 7 to 19.

FIG. 7 is a block diagram of a video encoding apparatus 100 based on coding units according to a tree structure, according to an embodiment.

The video encoding apparatus involving video prediction based on coding units according to a tree structure 100 according to an embodiment includes a largest coding unit splitter 110, a coding unit determiner 120 and an output unit 130. Hereinafter, for convenience of description, the video encoding apparatus involving video prediction based on coding units according to a tree structure 100 according to the embodiment will be abbreviated to the ‘video encoding apparatus 100’.

The largest coding unit splitter 110 may split a current picture based on a largest coding unit that is a coding unit having a maximum size for a current picture of an image. If the current picture is larger than the largest coding unit, image data of the current picture may be split into the at least one largest coding unit. The largest coding unit according to the embodiment may be a data unit having a size of 32×32, 64×64, 128×128, 256×256, etc., wherein a shape of the data unit is a square having a width and length in squares of 2. The image data may be output to the coding unit determiner 120 according to the at least one largest coding unit.

A coding unit according to the embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit is an uppermost depth and a depth of the smallest coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to the embodiment is split according to depths, the image data of the spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 120 encodes at least one split region obtained by splitting a region of the largest coding unit according to depths, and determines a depth to output a finally encoded image data according to the at least one split region. In other words, the coding unit determiner 120 determines a depth by encoding the image data in the deeper coding units according to depths, according to the largest coding unit of the current picture, and selecting a depth having the least encoding error. The determined depth and the image data according to the largest coding unit are output to the output unit 130.

The image data in the largest coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one depth may be selected for each largest coding unit.

The size of the largest coding unit is split as a coding unit is hierarchically split according to depths, and the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when data is included in one largest coding unit, the encoding errors may differ according to regions in the one largest coding unit, and thus the depths may differ according to regions in the image data. Thus, one or more depths may be determined in one largest coding unit, and the image data of the largest coding unit may be divided according to coding units of at least one depth.

Accordingly, the coding unit determiner 120 may determine coding units having a tree structure included in the current largest coding unit. The ‘coding units having a tree structure’ according to the embodiment include coding units corresponding to a depth determined to be the depth, from among all deeper coding units included in the largest coding unit. A coding unit of a depth may be hierarchically determined according to depths in the same region of the largest coding unit, and may be independently determined in different regions. Similarly, a depth in a current region may be independently determined from a depth in another region.

A maximum depth according to the embodiment is an index related to the number of splitting times from a largest coding unit to a smallest coding unit. A first maximum depth according to the embodiment may denote the total number of splitting times from the largest coding unit to the smallest coding unit. A second maximum depth according to the embodiment may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. Here, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. For convenience of description, the prediction encoding and the transformation will now be described based on a coding unit of a current depth, in a largest coding unit.

The video encoding apparatus 100 according to the embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the largest coding unit, the prediction encoding may be performed based on a coding unit corresponding to a depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type according to the embodiment may selectively include partitions obtained by asymmetrically splitting the height or width of the prediction unit, such as 1:n or n:1, partitions that are obtained by geometrically splitting the prediction unit, and partitions having arbitrary shapes, as well as symmetrical partitions that are obtained by symmetrically splitting a height or width of the prediction unit.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to the embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the transformation unit may include a data unit for an intra mode and a transformation unit for an inter mode.

The transformation unit in the coding unit may be recursively split into smaller sized transformation units in the similar manner as the coding unit according to the tree structure. Thus, residual data in the coding unit may be divided according to the transformation unit having the tree structure according to transformation depths.

With respect to the transformation unit according to the embodiment, a transformation depth indicating the number of splitting times to reach the transformation unit by splitting the height and width of the coding unit may also be set. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a depth requires not only information about the depth, but also information related to prediction and transformation. Accordingly, the coding unit determiner 120 not only determines a depth having a least encoding error, but also determines a partition type in a prediction unit, a prediction mode according to prediction units, and a size of a transformation unit for transformation.

Coding units according to a tree structure in a largest coding unit and methods of determining a prediction unit/partition, and a transformation unit, according to one or more embodiments, will be described in detail below with reference to FIGS. 7 through 19.

The coding unit determiner 120 may measure an encoding error of deeper coding units according to depths by using Rate-Distortion Optimization based on Lagrangian multipliers.

The output unit 130 outputs the image data of the largest coding unit, which is encoded based on the at least one depth determined by the coding unit determiner 120, and information about the encoding mode according to the depth, in bitstreams.

The encoded image data may be a result of encoding residual data of an image.

The information about the encoding mode according to depth may include information about the depth, about the partition type in the prediction unit, the prediction mode, and the size of the transformation unit.

The information about the depth may be defined by using splitting information according to depths, which indicates whether encoding is performed on coding units of a lower depth instead of a current depth. If the current depth of the current coding unit is the coded depth, the current coding unit is encoded into a coding unit of the current depth, and thus the splitting information may be defined not to split the current coding unit to a lower depth. Alternatively, if the current depth of the current coding unit is not the coded depth, the encoding on the coding unit of the lower depth has to be tried, and thus the splitting information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and information about at least one encoding mode is determined for a coding unit of a depth, information about at least one encoding mode may be determined for one largest coding unit. Also, a coded depth of the image data of the largest coding unit may be different according to locations since the image data is hierarchically split according to depths, and thus information about the coded depths and the encoding mode may be set for the data.

Accordingly, the output unit 130 may assign corresponding encoding information about the corresponding coded depth and the encoding mode to at least one of the coding unit, the prediction unit, and a minimum unit included in the largest coding unit.

The minimum unit according to the embodiment is a square data unit obtained by splitting the smallest coding unit constituting the lowermost coded depth by 4. The minimum unit according to an embodiment may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Also, information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, prediction information, single direction prediction information, slice type information including a fourth slice type, etc. described above with reference to FIGS. 1 to 6D.

In the video encoding apparatus 100 of the simplest format according to an embodiment, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the current coding unit having a size of 2N×2N may maximally include four lower-depth coding units having a size of N×N.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined considering characteristics of the coding unit of various image sizes.

Thus, if an image having a high resolution or a large data amount is encoded in a conventional macroblock unit, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to the embodiment, image compression efficiency may be increased since a coding unit is adjusted while considering characteristics of an image while increasing a maximum size of a coding unit while considering a size of the image.

The video encoding apparatus 100 illustrated with reference to FIG. 7 may perform operations of the inter layer video encoding apparatus 10 described above with reference to FIG. 1.

The coding unit determiner 120 may perform operations of the intra prediction unit 12 of the video encoding apparatus 10, that is, may determine prediction units for intra prediction according to the coding units having a tree structure for each largest coding unit and then may perform the intra prediction on each prediction unit.

The output unit 130 may perform operations of the encoder 57 in the video encoding apparatus 10, that is, may encode an MPM flag for predicting an intra prediction mode on each prediction unit. When an intra prediction mode of a current prediction unit is the same as at least one of intra prediction modes of left/upper prediction units, a plurality of candidate intra prediction modes of the fixed number are determined without regard to whether the left intra prediction mode and the upper intra prediction mode are equal to or different from each other, and then, current intra mode information for the current prediction unit may be determined and encoded based on the candidate intra prediction modes.

The output unit 130 may determine the number of candidate intra prediction modes for each picture. Similarly, the number of candidate intra prediction modes may be determined for every slice, every largest coding unit, every coding unit, or every prediction unit. However, one or more embodiments are not limited thereto, and the number of candidate intra prediction modes may be determined repeatedly for each of predetermined data units.

The output unit 130 may encode information representing the number of candidate intra prediction modes as a parameter of various data unit levels such as a picture parameter set (PPS), a slice parameter set (SPS), a largest coding unit level, a coding unit level, a prediction unit level, etc. according to the data unit level on which the number of candidate intra prediction modes is updated. However, even if the number of candidate intra prediction modes is determined on each of a predetermined data unit, the information representing the number of the candidate intra prediction modes is not always encoded.

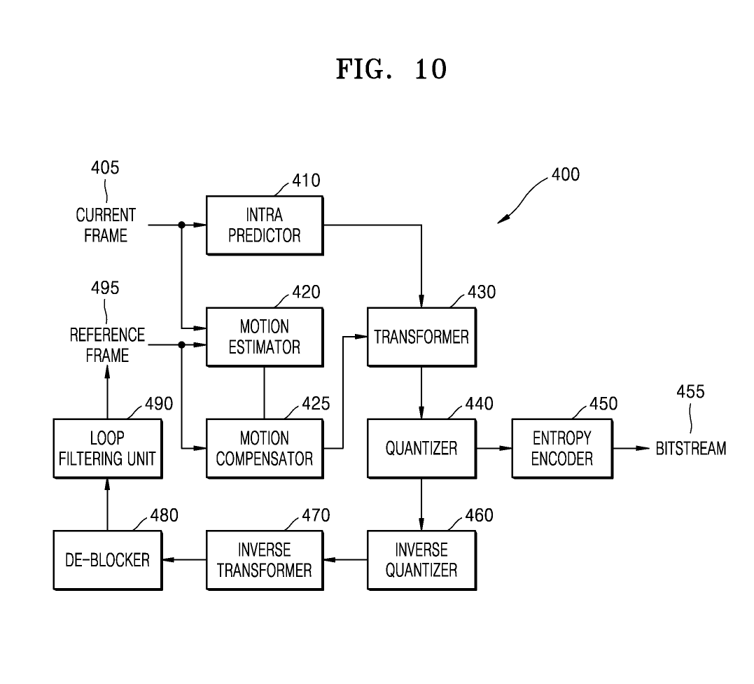

FIG. 8 is a block diagram of the video decoding apparatus 200 based on coding units having a tree structure, according to an embodiment.

The video decoding apparatus involving video prediction based on coding units having a tree structure 200 according to the embodiment includes a receiver 210, an image data and encoding information extractor 220, and an image data decoder 230. For convenience of description, the video decoding apparatus involving video prediction based on coding units having a tree structure 200 according to the embodiment will be abbreviated to the ‘video decoding apparatus 200’.

Definitions of various terms, such as a coding unit, a depth, a prediction unit, a transformation unit, and information about various encoding modes for decoding operations of the video decoding apparatus 200 according to the embodiment are identical to those described with reference to FIG. 7 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts information about coded depths and encoding modes for the coding units having a tree structure according to each largest coding unit, from the parsed bitstream. The extracted information about the coded depths and the encoding modes are output to the image data decoder 230. In other words, the image data in a bit stream is split into the largest coding unit so that the image data decoder 230 decodes the image data for each largest coding unit.

The information about the coded depths and the encoding modes according to the largest coding unit may be set for at least one piece of coded depth information, and information about the encoding information according to the coded depth may include information about a partition type of a corresponding coding unit, information about a prediction mode, and information about a size of a transformation unit. Also, splitting information according to depths may be extracted as the information about a coded depth.

The information about the coded depth and the encoding mode according to each largest coding unit extracted by the image data and encoding information extractor 220 is information about the coded depth and the encoding mode determined to generate a minimum encoding error when an encoder, such as the video encoding apparatus 100, repeatedly performs encoding for each deeper coding unit according to depths according to each largest coding unit. Accordingly, the video decoding apparatus 200 may reconstruct an image by decoding the data according to a decoding method that generates the minimum encoding error.

Since the encoding information about the coded depth and the encoding mode according to the embodiment may be assigned to a predetermined data unit from among a corresponding coding unit, a prediction unit, and a minimum unit, the image data and encoding information extractor 220 may extract the information about the coded depth and the encoding mode according to the predetermined data units. If information about the coded depth and the encoding mode of a corresponding largest coding unit are recorded according to predetermined data units, the predetermined data units to which the same information about the coded depth and the encoding mode is assigned may be inferred to be the data units included in the same largest coding unit.

The image data decoder 230 reconstructs the current picture by decoding the image data in each largest coding unit based on the information about the coded depth and the encoding mode according to the largest coding units. In other words, the image data decoder 230 may decode the encoded image data based on the extracted information about the partition type, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Via the inverse transformation, a pixel value of the spatial domain of the coding unit may be reconstructed.

The image data decoder 230 may determine a coded depth of a current largest coding unit by using splitting information according to depths. If the splitting information indicates that image data is no longer split in the current depth, the current depth is the coded depth. Accordingly, the image data decoder 230 may decode image data in the current largest coding unit by using the information about the partition type of the prediction unit, the information about the prediction mode, and the size information of the transformation unit.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

Also, the video decoding apparatus 200 illustrated with reference to FIG. 8 may perform operations of the video decoding apparatus 20 described above with reference to FIG. 2.

The receiver 210 may perform operations of the parser 22 in the video decoding apparatus 22. The image data and encoding information extractor 220 and the image data decoder 230 may perform operations of the intra prediction unit 24 of the video decoding apparatus 20.

When the prediction unit for the intra prediction is determined according to the coding units according to a tree structure, the parser 22 may parse an MPM flag for predicting the intra prediction mode from a bitstream for every prediction unit. There is no need to determine whether the left intra prediction mode and the upper intra prediction mode are equal to or different from each other, and current intra mode information may be parsed consecutively after the MPM flag from the bitstream. The image data and encoding information extractor 220 may reconstruct the current intra prediction mode from parsed information, after finishing the parsing of the blocks including the MPM flag and the intra mode information. The current intra prediction mode may be predicted by using a plurality of candidate intra prediction modes, wherein the number of candidate intra prediction modes is fixed. The image data decoder 230 may perform intra prediction on the current prediction unit by using reconstructed current intra prediction mode and residual data.

The image data and encoding information extractor 220 may determine the number of candidate intra prediction modes repeatedly for every picture.

The parser 22 may parse information indicating the number of the candidate intra prediction modes, the number of which is fixed, from parameters of various data unit levels, for example, a PPS, an SPS, a largest coding unit level, a coding unit level, a prediction unit level, etc. of the bitstream. In this case, the image data and encoding information extractor 220 may determine the candidate intra prediction modes, the number of which is indicated by the parsed information, for each data unit corresponding to the level from which the information is parsed.

However, the image data and encoding information extractor 220 may update the number of candidate intra prediction modes at every predetermined data unit such as the slice, the largest coding unit, the coding unit, the prediction unit, etc., even if the information indicating the number of candidate intra prediction modes is not parsed.

That is, the video decoding apparatus 200 may obtain information about the coding unit that generates the minimum encoding error when encoding is recursively performed for each largest coding unit, and may use the information to decode the current picture. In other words, the encoded image data of the coding units having the tree structure determined to be the optimum coding units in each largest coding unit may be decoded.

Accordingly, even if image data has high resolution and an excessively large amount of data, the image data may be efficiently decoded and reconstructed by using a size of a coding unit and an encoding mode, which are adaptively determined according to characteristics of the image data, by using information about an optimum encoding mode received from an encoder.

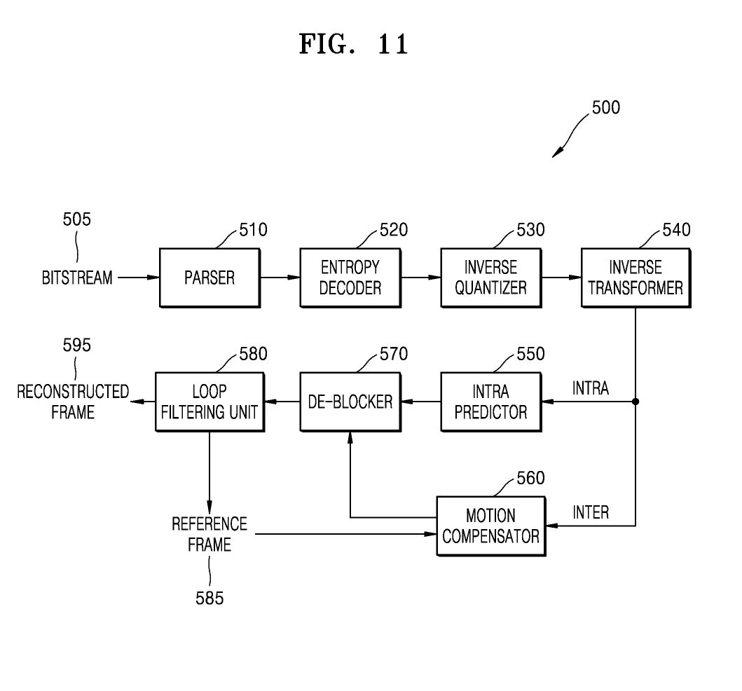

FIG. 9 is a diagram for describing a concept of coding units according to an embodiment.

As an example of a coding unit, a size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 9 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the video data 310 may include a largest coding unit having a long axis size of 64, and coding units having long axis sizes of 32 and 16 since depths are deepened to two layers by splitting the largest coding unit twice. Since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, detailed information may be precisely expressed.

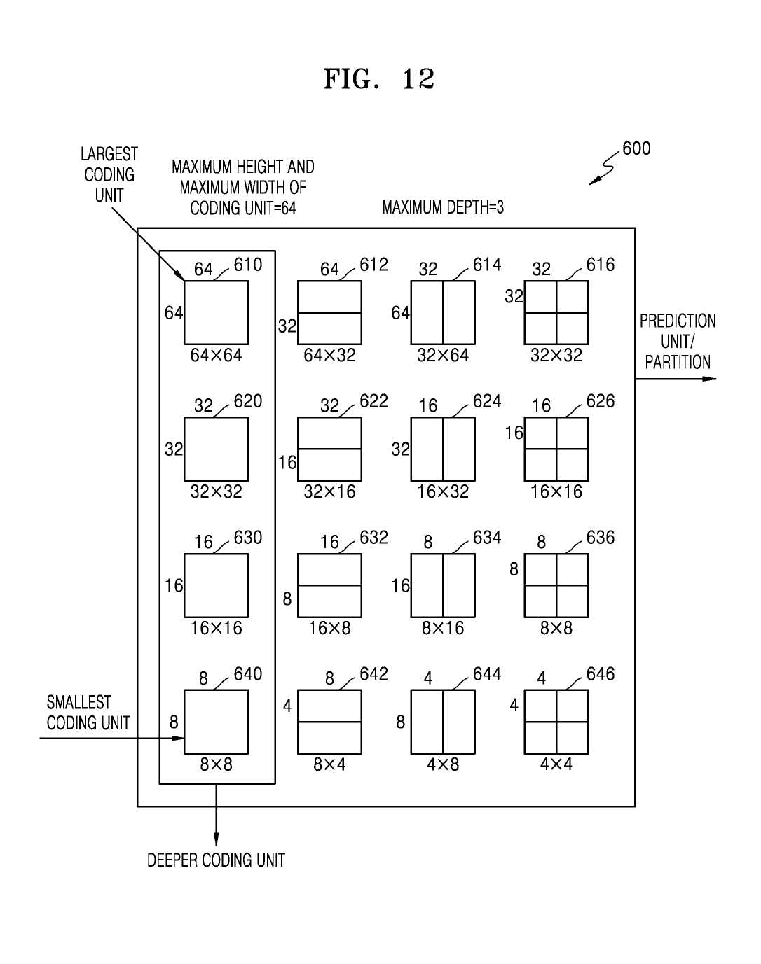

FIG. 10 is a block diagram of an image encoder 400 based on coding units, according to an embodiment.

The image encoder 400 performs operations necessary for encoding image data in the coding unit determiner 120 of the video encoding apparatus 100. In other words, an intra predictor 410 performs intra prediction on coding units in an intra mode according to prediction units, from among a current frame 405, and a motion estimator 420 and a motion compensator 425 perform an inter prediction and a motion compensation by using a current frame 405 and a reference frame 495 in the inter mode.

Data output from the intra predictor 410, the motion estimator 420, and the motion compensator 425 is output as a quantized transformation coefficient through a transformer 430 and a quantizer 440. The quantized transformation coefficient is reconstructed as the data in a spatial domain through an inverse quantizer 460 and an inverse transformer 470. The reconstructed data in the spatial domain is post-processed through a de-blocker 480 and a loop filtering unit 490 and output as a reference frame 495. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 470, the de-blocker 480, and the loop filtering unit 490, perform operations based on each coding unit among coding units having a tree structure according to each largest coding unit while considering the maximum depth.

In particular, the intra predictor 410, the motion estimator 420, and the motion compensator 425 determine partitions and a prediction mode of each coding unit from among the coding units having a tree structure while considering the maximum size and the maximum depth of a current largest coding unit, and the transformer 430 determines the size of the transformation unit in each coding unit from among the coding units having a tree structure.

Specifically, the intra predictor 410 may perform operations of the intra prediction unit 12 of the video encoding apparatus 10, that is, determine a prediction unit for intra prediction according to coding units of a tree structure for each largest coding unit, and perform the intra prediction on each prediction unit.

When the current prediction unit is the same as the left/upper prediction units and the left intra prediction mode and the upper intra prediction mode are the same as or different from each other, a plurality of candidate intra prediction modes are determined. Thus, the entropy encoder 450 encodes an MPM flag on every prediction unit, and then, may encode current intra mode information determined based on the candidate intra prediction modes for the current prediction unit.

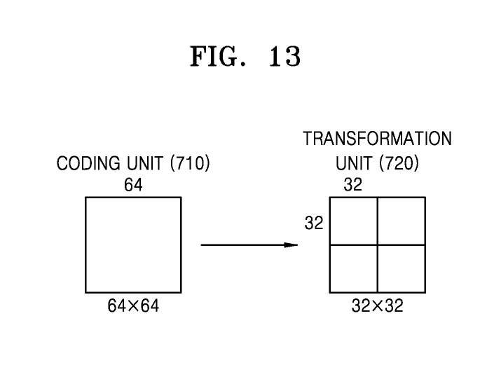

FIG. 11 is a block diagram of an image decoder 500 based on coding units, according to an embodiment.

Image data that is to be decoded and encoding information required for decoding from a bitstream 505 is parsed through a parser 510. The encoded image data is output as inverse quantized data through an entropy encoder 520 and an inverse quantizer 530, and image data in a spatial domain is reconstructed through an inverse transformer 540.

An intra predictor 550 performs intra prediction on a coding unit of an intra mode in the image data in a spatial domain, and a motion compensator 560 performs motion compensation on the cording unit of the inter mode by using a reference frame 585.

The data in the spatial domain passed through the intra predictor 550 and the motion compensator 560 may be post-processed through a de-blocker 570 and a loop filtering unit 580 and output as a reconstruction frame 595. Also, the data post-processed through the de-blocker 570 and the loop filtering unit 580 may be output as a reference frame 585.

In order to decode the image data in the image data decoder 230 of the video decoding apparatus 200, operations after the parser 510 of the image decoder 500 according to an embodiment may be performed.

In order for the image decoder 500 to be applied in the video decoding apparatus 200 according to an embodiment, all elements of the image decoder 500, i.e., the parser 510, an entropy decoder 520, the inverse quantizer 530, the inverse transformer 540, the intra predictor 550, the motion compensator 560, the de-blocker 570, and the loop filtering unit 580 may perform operations based on coding units having a tree structure for each largest coding.

In particular, the intra predictor 550 and the motion compensator 560 may determine a partition and a prediction mode for each of the coding units having a tree structure, and the inverse transformer 540 may determine a size of the transformation unit for each of the coding units.

In particular, when the prediction unit for the intra prediction is determined for each of the coding units of a tree structure, the parser 510 may parse an MPM flag for predicting an intra prediction mode for every prediction unit from the bitstream. There is no need to determine whether the left intra prediction mode and the upper intra prediction mode are the same as or different from each other, current intra mode information may be parsed from the bitstream in addition to the MPM flag. The entropy encoder 520 may reconstruct the current intra prediction mode from parsed information, after finishing the parsing of the symbols of the blocks including the MPM flag and the current intra mode information. The intra predictor 550 may perform intra prediction on the current prediction unit by using the reconstructed current intra prediction mode and residual data.

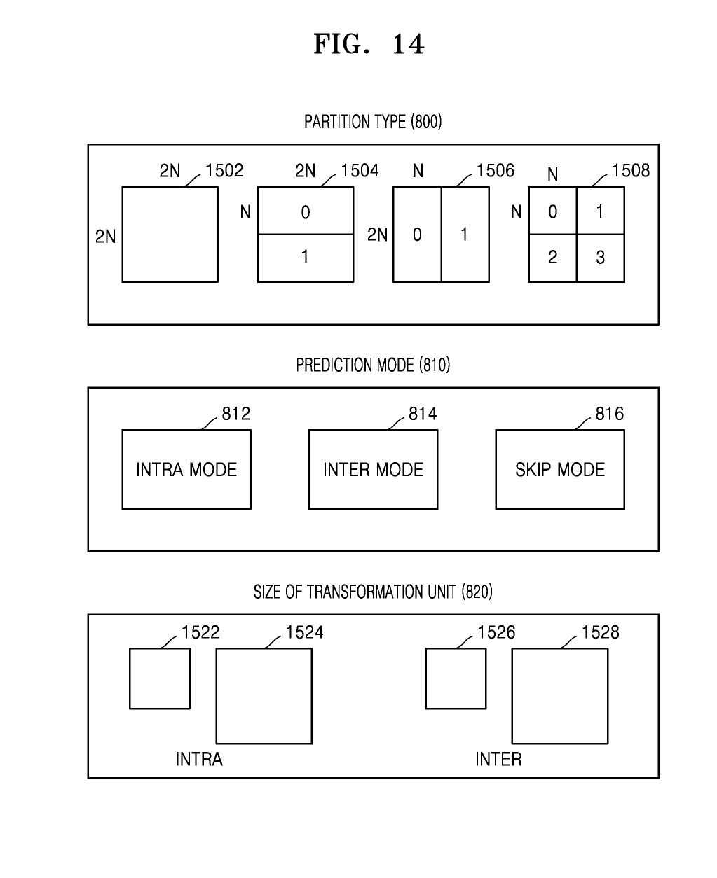

FIG. 12 is a diagram illustrating deeper coding units according to depths, and partitions, according to an embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units, according to the embodiment, the maximum height and the maximum width of the coding units are each 64, and the maximum depth is 4. In this case, the maximum depth refers to a total number of times the coding unit is split from the largest coding unit to the smallest coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4. The coding unit 650 having a size of 4×4 and a depth of 4 is a smallest coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610 having the size of 64×64, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620 having the size of 32×32, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630 having the size of 16×16, i.e. a partition 630 having a size of 16×16, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640 having the size of 8×8, i.e. a partition 640 having a size of 8×8, partitions 642 having a size of 8×4, partitions 644 having a size of 4×8, and partitions 646 having a size of 4×4.

Last, a prediction unit of the coding unit 650 having the size of 4×4 and the depth of 4 is a smallest coding unit and a coding unit of a lowest depth, and a prediction unit may include partitions 650 having a size 4×4.

In order to determine a coded depth of the largest coding unit 610, the coding unit determiner 120 of the video encoding apparatus 100 performs encoding for coding units corresponding to each depth included in the largest coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding of the coding units according to depths, a least encoding error, that is, a representative encoding error, may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the largest coding unit 610 may be selected as the coded depth and a partition type of the largest coding unit 610.

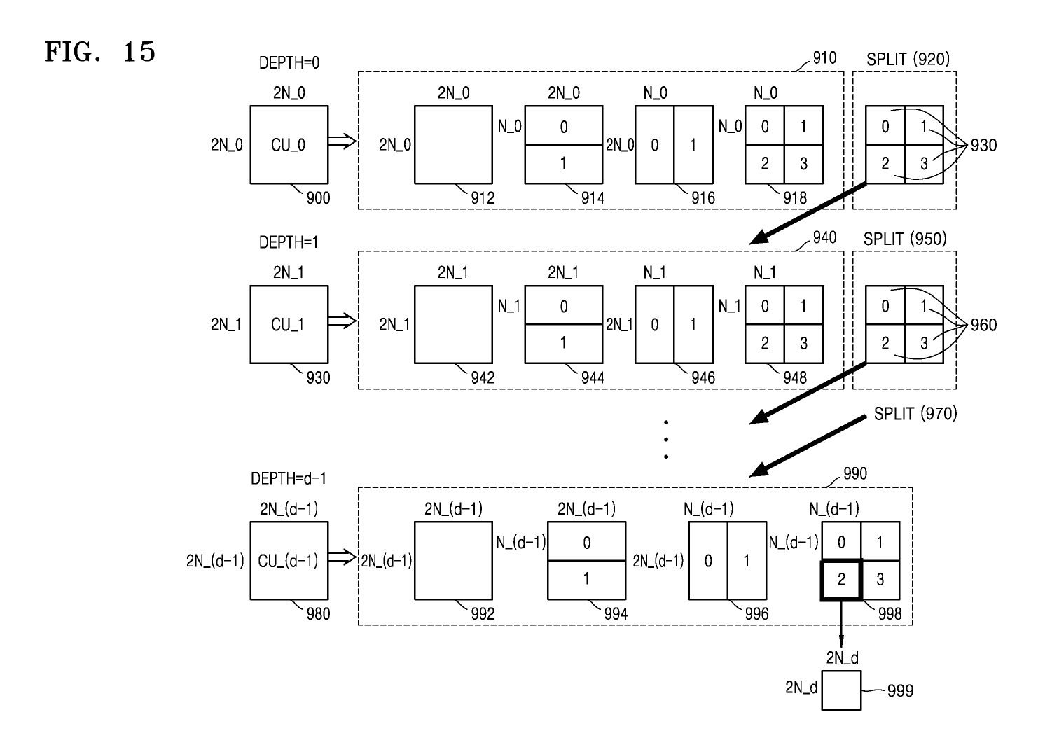

FIG. 13 is a diagram for describing a relationship between a coding unit and transformation units, according to an embodiment.

The video encoding apparatus 100 or the video decoding apparatus 200 accoridng to the embodiment encodes or decodes an image according to coding units having sizes smaller than or equal to a largest coding unit for each largest coding unit. Sizes of transformation units for transformation during encoding may be selected based on data units that are not larger than a corresponding coding unit.

For example, in the video encoding apparatus 100 or the video decoding apparatus 200 according to the embodiment, if a size of a current coding unit 710 is 64×64, transformation may be performed by using transformation units 720 having a size of 32×32.

Also, data of the coding unit 710 having the size of 64×64 may be encoded by performing the transformation on each of the transformation units having the size of 32×32, 16×16, 8×8, and 4×4, which are equal to or smaller than 64×64, and then a transformation unit having the least coding error may be selected.

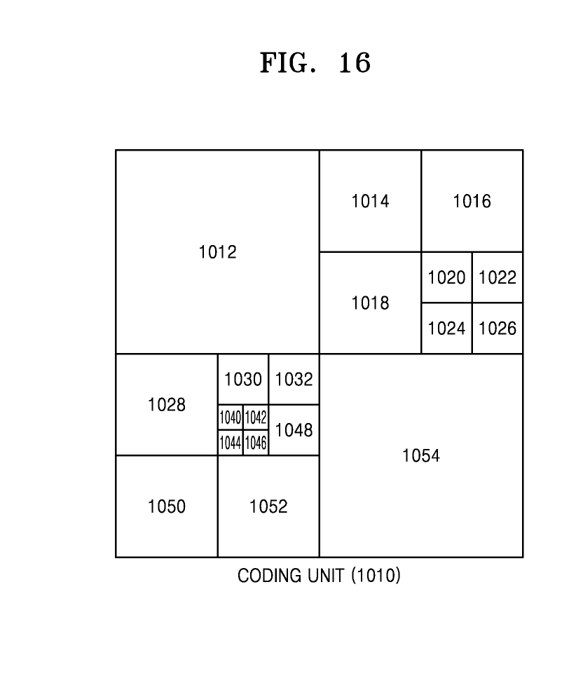

FIG. 14 is a diagram for describing encoding information of coding units corresponding to a depth, according to an embodiment.

The output unit 130 of the video encoding apparatus 100 according to the embodiment may encode and transmit information 800 about a partition type, information 810 about a prediction mode, and information 820 about a size of a transformation unit for each coding unit corresponding to a coded depth, as information about an encoding mode.

The information 800 about the partition type indicates information about a type of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type of the current coding unit is set to indicate one of the partition 802 having a size of 2N×2N, the partition 804 having a size of 2N×N, the partition 806 having a size of N×2N, and the partition 808 having a size of N×N.

The information 810 about the prediction mode indicates a prediction mode of each partition. For example, the information 810 may indicate a mode of prediction encoding performed on a partition indicated by the information 800, i.e., an intra mode 812, an inter mode 814, or a skip mode 816.

The information 820 about the size of the transformation unit indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 210 of the video decoding apparatus 200 may extract and use the information 800 about the partition type, the information 810 about the prediction mode, and the information 820 about the size of transformation unit for decoding, according to each deeper coding unit.

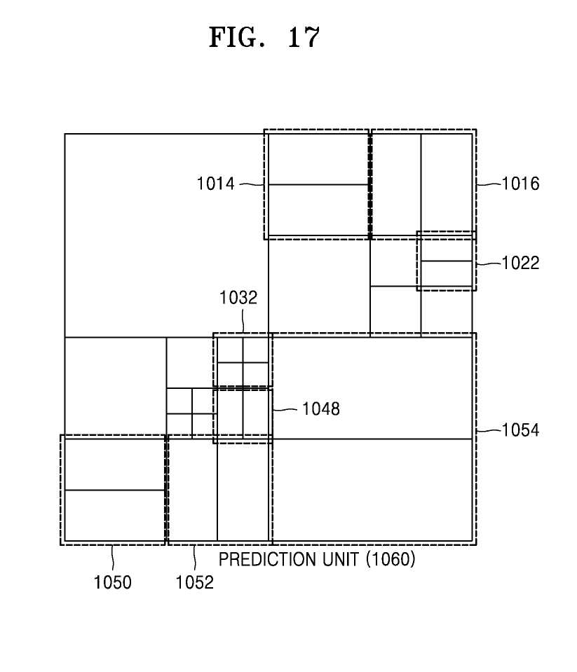

FIG. 15 is a diagram of deeper coding units according to depths, according to one or more embodiments.

Splitting information may be used to indicate a change of a depth. The splitting information indicates whether a coding unit of a current depth is split into coding units of a lower depth.

A prediction unit 910 for prediction encoding a coding unit 900 having a depth of 0 and a size of 2N_0×2N_0 may include partitions of a partition type 912 having a size of 2N_0×2N_0, a partition type 914 having a size of 2N_0×N_0, a partition type 916 having a size of N_0×2N_0, and a partition type 918 having a size of N_0×N_0. FIG. 15 only illustrates the partitions 912 to 918 which are obtained by symmetrically splitting the prediction unit, but a partition type is not limited thereto, and the partitions may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912 to 916 having the sizes of 2N_0×2N_0, 2N_0×N_0, and N_0×N_0, the prediction unit may not be split into a lower depth.

If the encoding error is the smallest in the partition mode 918 having a size of N_0×N_0, a depth is changed from 0 to 1 to split the partition mode 918 in operation 920, and encoding is repeatedly performed on coding units 930 having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition type 942 having a size of 2N_1×2N_1, a partition type 944 having a size of 2N_1×N_1, a partition mode 946 having a size of N_1×2N_1, and a partition type 948 having a size of N_1×N_1.

If an encoding error is the smallest in the partition mode 948 having a size of N_1×N_1, a depth is changed from 1 to 2 to split the partition mode 948 in operation 950, and encoding is repeatedly performed on coding units 960, which have a depth of 2 and a size of N_2×N_2 to search for a minimum encoding error.

When a maximum depth is d, deeper coding units according to depths may be set until when a depth corresponds to d−1, and splitting information may be set until when a depth corresponds to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) to search for a partition mode having a minimum encoding error.

Even when the partition type 998 having a size of N_(d−1)×N_(d−1) has the minimum encoding error, since a maximum depth is d, a coding unit CU_(d−1) having a depth of d−1 is no longer split to a lower depth, and a depth for a current largest coding unit 900 is determined to be d−1 and a partition type of the current largest coding unit 900 may be determined to be N_(d−1)×N_(d−1). Also, since the maximum depth is d, splitting information for the coding unit 952 corresponding to a depth d−1 is not set.

A data unit 999 may be a ‘minimum unit’ for the current largest coding unit. A minimum unit according to the embodiment may be a square data unit obtained by splitting a smallest coding unit, that is, a lowest coded depth by 4. By performing the encoding repeatedly, the video encoding apparatus 100 may select a depth having the least encoding error by comparing encoding errors according to depths of the coding unit 900 to determine a coded depth, and set a corresponding partition mode and a prediction mode as an encoding mode of the coded depth.

As such, the minimum encoding errors according to depths are compared in all of the depths of 0, 1, . . . , d−1, and d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only splitting information of the coded depth is set to 0, and splitting information of depths excluding the coded depth is set to 1.

The image data and encoding information extractor 220 of the video decoding apparatus 200 according to the embodiment may extract and use the information about the coded depth and the prediction unit of the coding unit 900 to decode the coding unit 912. The video decoding apparatus 200 according to the embodiment may determine a depth, in which splitting information is 0, as a coded depth by using splitting information according to depths, and use information about an encoding mode of the corresponding depth for decoding.

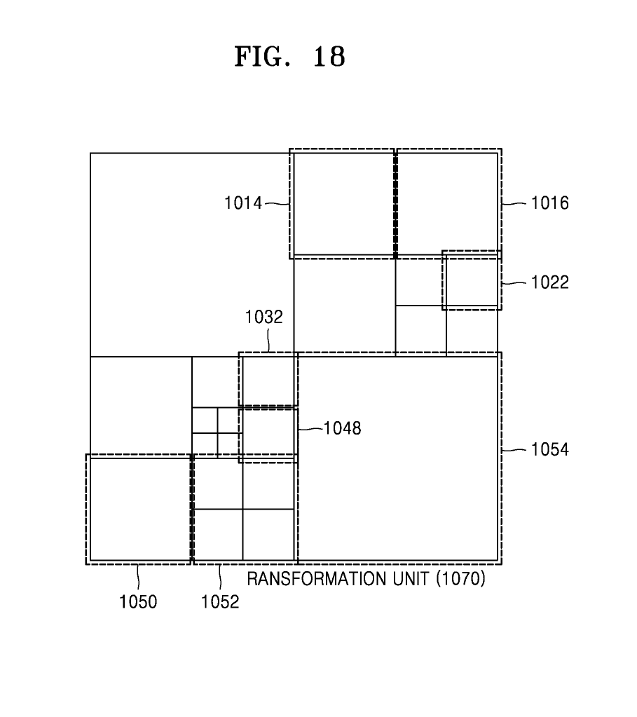

FIGS. 16 to 18 are diagrams for describing a relationship between coding units, prediction units, and transformation units, according to an embodiment.

The coding units 1010 are coding units having a tree structure, corresponding to depths determined by the video encoding apparatus 100 according to the embodiment, in a largest coding unit. The prediction units 1060 are partitions of prediction units of each of the coding units 1010, and the transformation units 1070 are transformation units of each of the coding units according to depths.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partitions 1014, 1022, 1050, and 1054 are partition types having a size of 2N×N, partitions 1016, 1048, and 1052 are partition types having a size of N×2N, and a partition 1032 is a partition type having a size of N×N. Prediction units and partitions of the coding units 1010 according to depths are smaller than or equal to each coding unit.

Transformation or inverse transformation is performed on image data of some 1052 of the transformation units 1070 in a data unit that is smaller than the coding unit. Also, the transformation units 1014, 1016, 1022, 1032, 1048, 1050, and 1052 are data units different from those in the prediction units in terms of sizes and shapes. In other words, the video encoding and decoding apparatuses 100 and 200 according to the embodiment may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include splitting information about a coding unit, information about a partition type, information about a prediction mode, and information about a size of a transformation unit. Table 1 shows the encoding information that may be set by the video encoding and decoding apparatuses 100 and 200 according to the embodiment.

TABLE 1

| | | | | | Split |
|---|---|---|---|---|---|
| Split Information 0 | | | | | Information |
| (Encoding on Coding Unit having Size of 2N × 2N and Current Depth of d) | | | | | 1 |
| Prediction | Partition Type | | Size of Transformation Unit | | Repeatedly |
| Mode | | | | | Encode |
| Intra | Symmetrical | Asymmetrical | Split | Split | Coding |
| Inter | Partition | Partition | Information 0 of | Information 1 of | Units |
| Skip | Type | Type | Transformation | Transformation | having |
| (Only | | | Unit | Unit | Lower |
| 2N × 2N) | 2N × 2N | 2N × nU | 2N × 2N | N × N | Depth of |
| | 2N × N | 2N × nD | | (Symmetrical | d + 1 |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 according to the embodiment may output the encoding information about the coding units having a tree structure, and the image data and encoding information extractor 220 of the video decoding apparatus 200 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure according to the embodiment may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a largest coding unit may be determined.

Accordingly, if a current coding unit is predicted based on encoding information of adjacent data units, encoding information of data units in deeper coding units adjacent to the current coding unit may be directly referred to and used.

As another embodiment, if a current coding unit is predicted by referring to adjacent coding units, data adjacent to the current coding unit are searched using encoding information of the adjacent coding units according to depths, and the searched adjacent coding units may be referred for predicting the current coding unit.

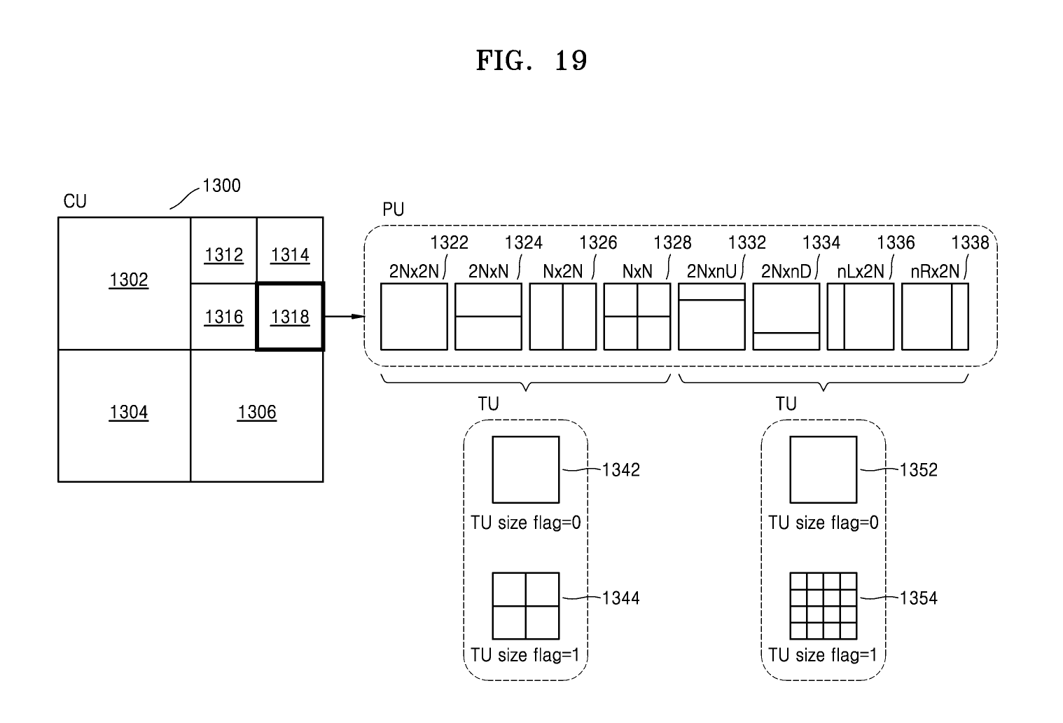

FIG. 19 is a diagram for describing a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a coded depth, splitting information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Splitting information (TU size flag) of a transformation unit is a type of a transformation index. The size of the transformation unit corresponding to the transformation index may be changed according to a prediction unit type or partition type of the coding unit.

For example, when the partition type is set to be symmetrical, i.e. the symmetrical partition type 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition type is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 21, the TU size flag is a flag having a value or 0 or 1, but the TU size flag is not limited to 1 bit, and a transformation unit may be hierarchically split having a tree structure while the TU size flag increases from 0, 1, 2, 3 . . . . Splitting information (TU size flag) of a transformation unit may be an example of a transformation index.

In this case, the size of a transformation unit that has been actually used may be expressed by using a TU size flag of a transformation unit, according to the embodiment, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that may be determined in the current coding unit, a transformation unit size ‘RootTuSize’ when the TU size flag is 0 may denote a maximum transformation unit size that may be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that may be determined in the current coding unit.

According to one or more embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the embodiments are not limited thereto.

According to the video encoding method based on coding units having a tree structure as described with reference to FIGS. 7 through 19, image data of the spatial domain is encoded for each coding unit of a tree structure. According to the video decoding method based on coding units having a tree structure, decoding is performed for each largest coding unit to reconstruct image data of the spatial domain. Thus, a picture and a video that is a picture sequence may be reconstructed. The reconstructed video may be reproduced by a reproducing apparatus, stored in a storage medium, or transmitted through a network.

The embodiments may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the video encoding method and/or the video encoding method described above with reference to FIGS. 1A through 19, will be referred to as a ‘video encoding method according to the various embodiments’. In addition, the video decoding method and/or the video decoding method described above with reference to FIGS. 1A through 19, will be referred to as a ‘video decoding method according to the various embodiments’.

A video encoding apparatus including the video encoding apparatus, the video encoding apparatus, or the video encoder, which is described above with reference to FIGS. 1A through 19, will be referred to as a ‘video encoding apparatus according to the various embodiments’. In addition, a video decoding apparatus including the inter-layer video decoding apparatus, the video decoding apparatus, or the video decoder, which is described above with reference to FIGS. 1A through 19, will be referred to as a ‘video decoding apparatus according to the various embodiments’.

A computer-readable recording medium storing a program, e.g., a disc 26000, according to an embodiment will now be described in detail.

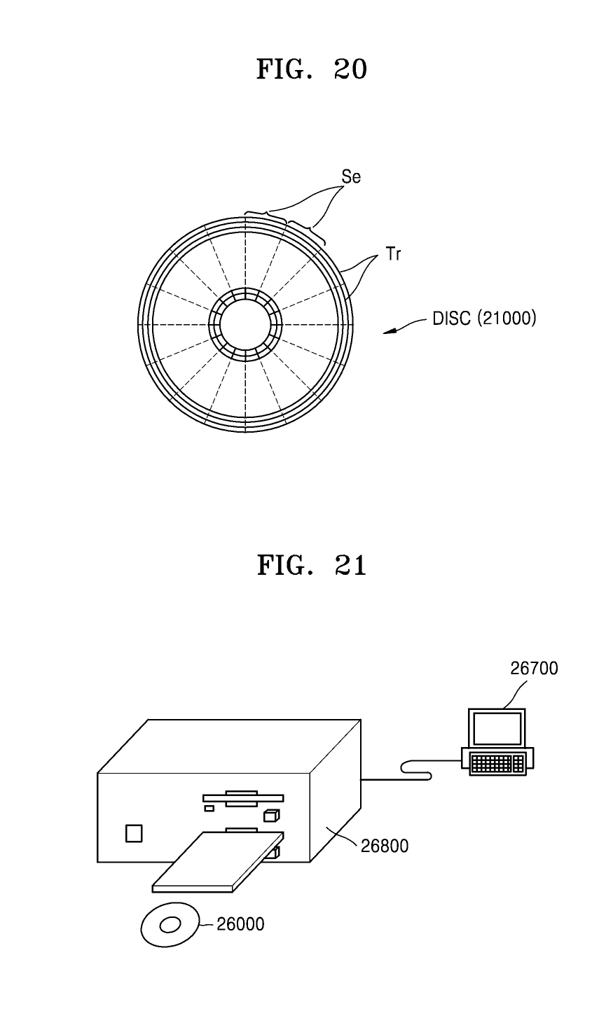

FIG. 20 is a diagram of a physical structure of the disc 26000 in which a program is stored, according to an embodiment. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction. In a specific region of the disc 26000, a program that executes the quantization parameter determination method, the video encoding method, and the video decoding method described above may be assigned and stored.

A computer system embodied using a storage medium that stores a program for executing the video encoding method and the video decoding method as described above will now be described with reference to FIG. 21.

FIG. 21 is a diagram of a disc drive 26800 for recording and reading a program by using the disc 26000. A computer system 26700 may store a program that executes at least one of a video encoding method and a video decoding method according to one or more embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method according to one or more embodiments may be stored not only in the disc 26000 illustrated in FIG. 20 or 21 but also in a memory card, a ROM cassette, or a solid state drive (SSD).

A system to which the video encoding method and a video decoding method described above are applied will be described below.

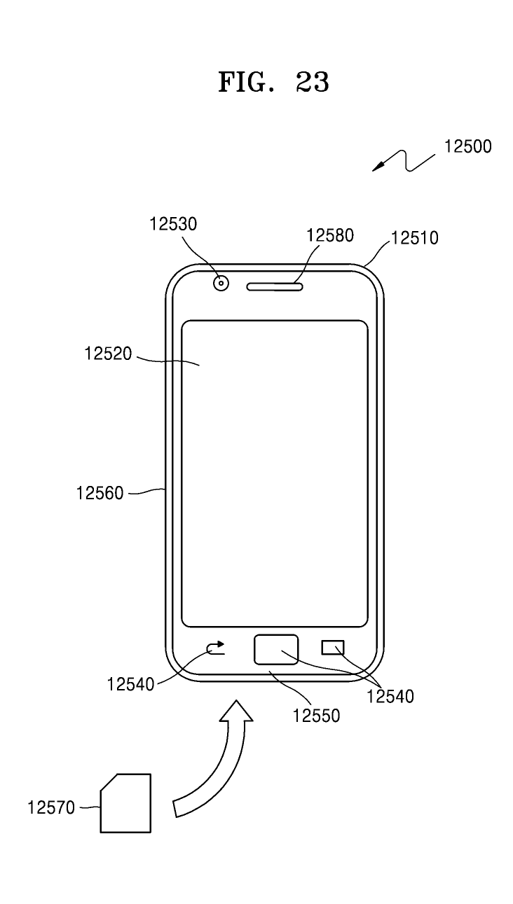

FIG. 22 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 22 and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to one or more embodiments.

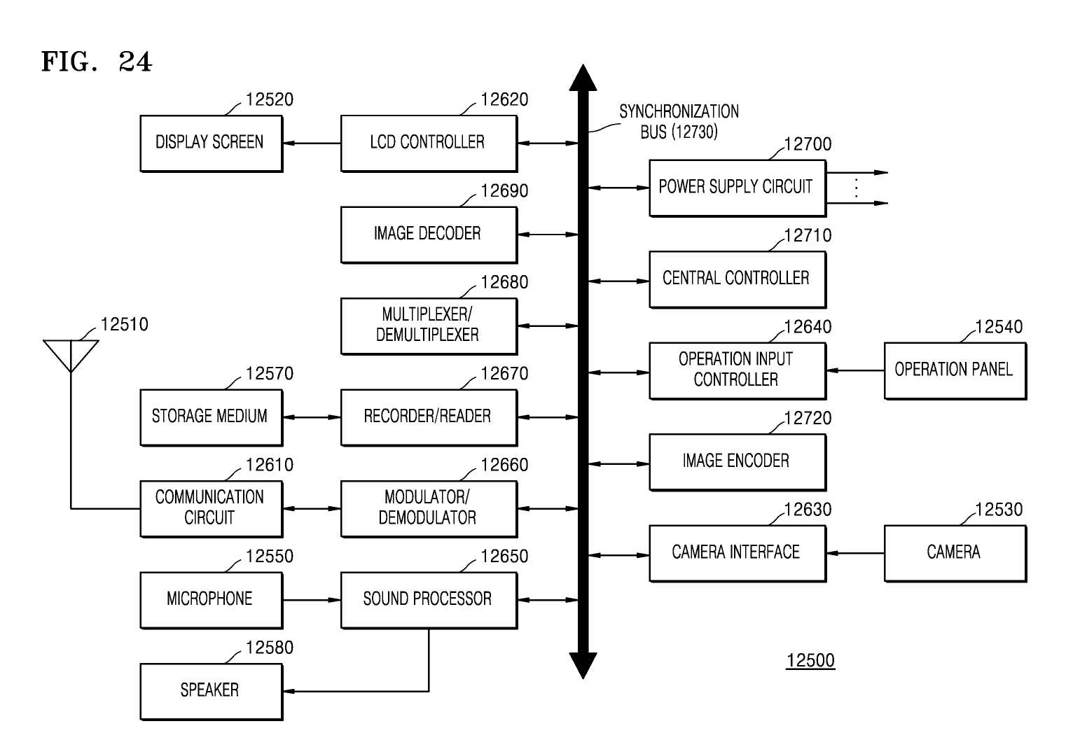

The mobile phone 12500 included in the content supply system 11000 according to one or more embodiments will now be described in greater detail with referring to FIGS. 23 and 24.

FIG. 23 illustrates an external structure of the mobile phone 12500 to which a video encoding method and a video decoding method are applied, according to one or more embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound outputter, and a microphone 12550 for inputting voice and sound or another type sound inputter. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 24 illustrates an internal structure of the mobile phone 12500. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding apparatus according to the one or more embodiments. The image encoder 12720 may transform the image data received from the camera 12530 into compressed and encoded image data based on the above-described video encoding method according to the one or more embodiments, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the above-described video decoding method according to the one or more embodiments. The image decoder 12690 may decode the encoded video data to obtain reconstructed video data and provide the reconstructed video data to the display screen 12520 via the LCD controller 12620, by using the above-described video decoding method according to the one or more embodiments.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to one or more embodiments, may be a transmitting terminal including only the video encoding apparatus, or may be a receiving terminal including only the video decoding apparatus.

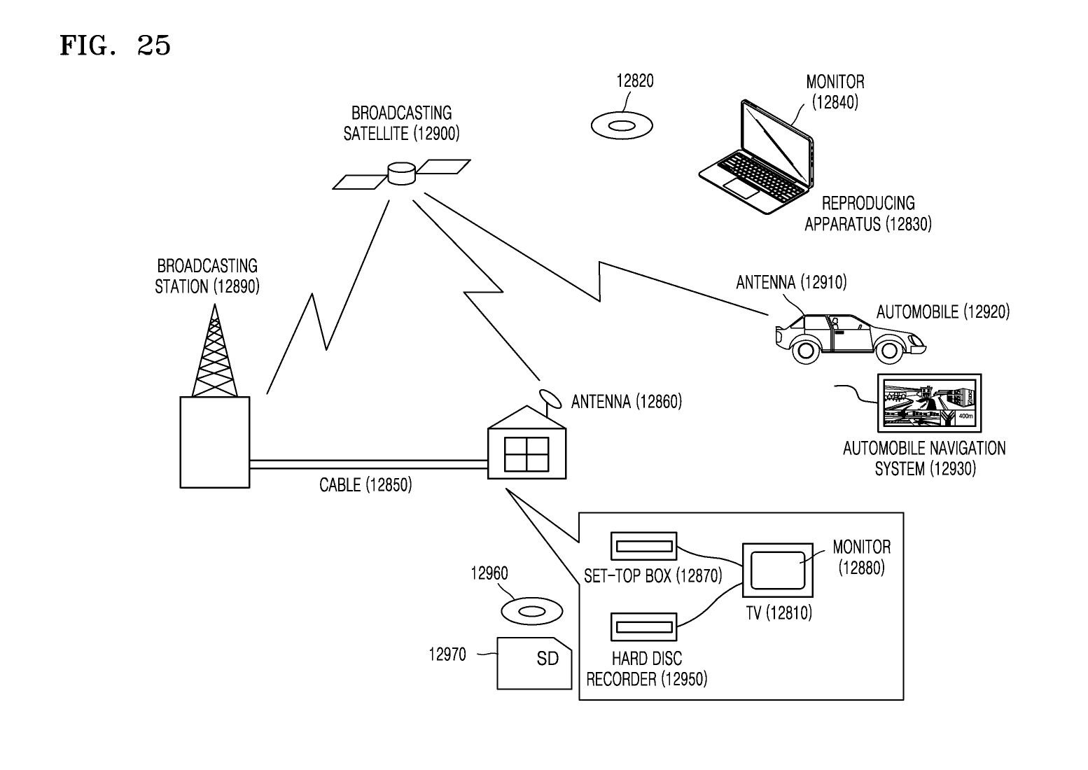

A communication system according to the one or more embodiments is not limited to the communication system described above with reference to FIG. 24. For example, FIG. 25 illustrates a digital broadcasting system employing a communication system, according to one or more embodiments.

The digital broadcasting system of FIG. 25 may receive a digital broadcast transmitted via a satellite or a terrestrial network by using a video encoding apparatus and a video decoding apparatus according to one or more embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to one or more embodiments is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to one or more embodiments may be installed. Data output from the set-top box 12870 may also be reproduced on a TV monitor 12880.

As another example, a video decoding apparatus according to one or more embodiments may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by a video encoding apparatus according to one or more embodiments and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to one or more embodiments, a video signal recorded on the DVD disc 12960, the SD card 12970, or another storage medium may be reproduced on the TV monitor 12880.

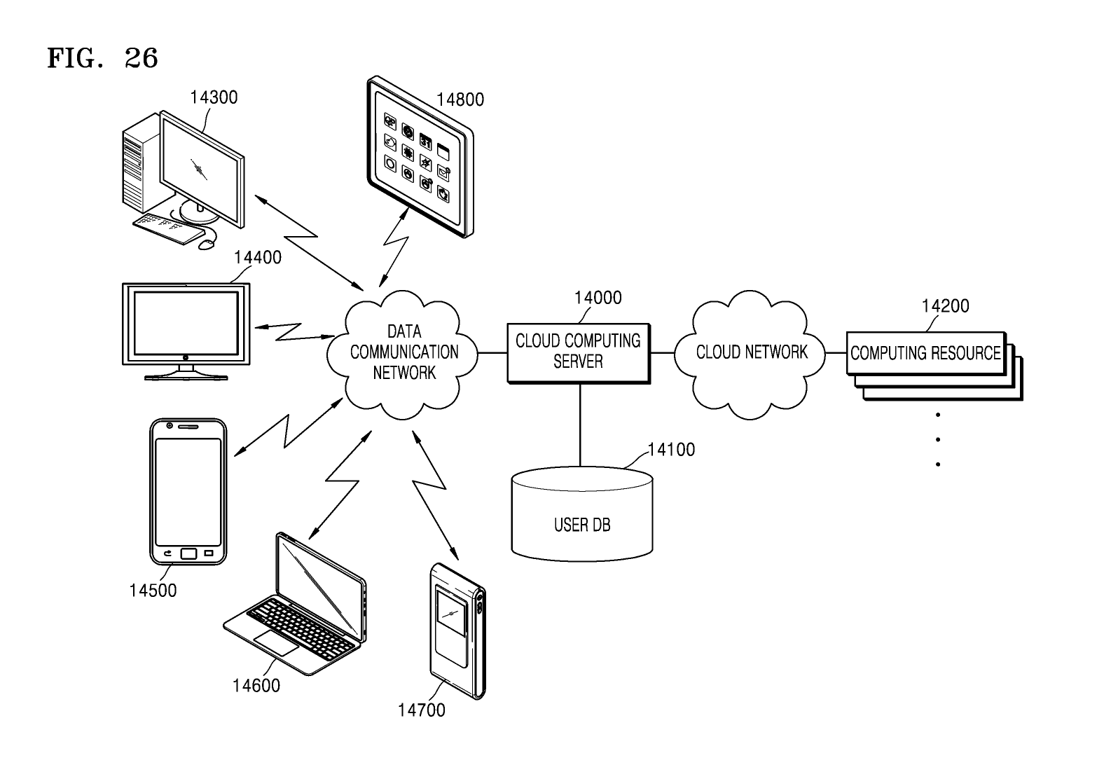

The automobile navigation system 12930 may not include the camera 12530 of FIG. 26, and the camera interface 12630 and the image encoder 12720 of FIG. 26. For example, the computer 12100 and the TV receiver 12810 may not include the camera 12530, the camera interface 12630, and the image encoder 12720 of FIG. 26.

FIG. 26 is a diagram illustrating a network structure of a cloud computing system using a video encoding apparatus and a video decoding apparatus, according to one or more embodiments.

The cloud computing system may include a cloud computing server 14000, a user database (DB) 14100, a plurality of computing resources 14200, and a user terminal.

The cloud computing system provides an on-demand outsourcing service of the plurality of computing resources via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1A through 19. As another example, the user terminal may include a video encoding apparatus as described above with reference to FIGS. 1A through 19. Alternatively, the user terminal may include both the video decoding apparatus and the video encoding apparatus as described above with reference to FIGS. 1A through 19.

Various applications of a video encoding method, a video decoding method, a video encoding apparatus, and a video decoding apparatus according to the one or more embodiments described above with reference to FIGS. 1A through 19 have been described above with reference to FIGS. 20 to 26. However, methods of storing the video encoding method and the video decoding method in a storage medium or methods of implementing the video encoding apparatus and the video decoding apparatus in a device, according to various embodiments, described above with reference to FIGS. 1A through 19 are not limited to the embodiments described above with reference to FIGS. 20 to 26.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the inventive concept is that it valuably supports and services the historical trend of reducing costs, simplifying systems, and increasing performance. These and other valuable aspects of an embodiment of the inventive concept consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

1. An inter-layer video encoding method comprising:
configuring at least one prediction mode as a simplified depth coding (SDC) mode;
determining a prediction mode with respect to a current block of a depth image;
generating a prediction block of the current block by using the prediction mode; and
generating a bitstream by encoding the depth image by using the prediction block.

2. The inter-layer video encoding method of claim 1, wherein the configuring of the at least one prediction mode as the SDC mode comprises configuring at least one of a DC mode, a planar mode, an angular mode, a depth modeling mode (DMM), and a most probable mode (MPM) as the SDC mode.

3. The inter-layer video encoding method of claim 2, wherein the configuring of the at least one prediction mode as the SDC mode comprises setting the SDC mode to be different according to a size of a coding unit or a size of a prediction unit.

4. The inter-layer video encoding method of claim 3, wherein the setting of the SDC mode to be different comprises not configuring the at least one prediction mode as the SDC mode when the size of the coding unit or the size of the prediction unit is greater than a predetermined size.

5. The inter-layer video encoding method of claim 1, wherein the generating of the bitstream by encoding the depth image comprises inserting a flag representing whether a determined prediction mode is encoded in the SDC mode into the bitstream.

6. The inter-layer video encoding method of claim 1, wherein the generating of the bitstream by encoding the depth image comprises, when the determined prediction mode is the SDC mode, not encoding residual data that is difference between the prediction block and the current block or partially encoding the residual data.

7. The inter-layer video encoding method of claim 6, wherein the partial encoding of the residual data comprises averaging and encoding all or some of the residual data.

8. The inter-layer video encoding method of claim 7, wherein the averaging and encoding of some of the residual data comprises averaging and encoding an upper left pixel value, an upper right pixel value, a lower left pixel value, and a lower right pixel value of a residual block that is a difference between the prediction block and the current block.

9. The inter-layer video encoding method of claim 7, wherein the averaging and encoding of some of the residual data comprises averaging values of some pixels in the residual block that is the difference between the prediction block and the current block, and locations of the some pixels in the residual block are determined based on at least one of the prediction mode, and a size of a coding unit or a prediction unit.

10. An inter-layer video decoding method comprising:
obtaining prediction mode regarding a current block of a depth image from a bitstream;
determining whether the prediction mode is a simplified depth coding (SDC) mode;
generating a prediction block for the current block by using the prediction mode, according to a result of the determining of whether the prediction mode is the SDC mode; and
decoding the depth image by using the prediction block.

11. The inter-layer video decoding method of claim 10, wherein the SDC mode comprises at least one of a DC mode, a planar mode, an angular mode, a depth modeling mode (DMM), and a most probable mode (MPM).

12. The inter-layer video decoding method of claim 10, wherein the generating the prediction block for the current block comprises, when the prediction mode is the SDC mode, not decoding residual data that is difference between the prediction block and the current block or partially decoding the residual data.

13. An inter-layer video encoding apparatus comprising:
a simplified depth coding (SDC) mode configuration unit configured to configure at least one prediction mode as a SDC mode;
a prediction mode determiner configured to determine a prediction mode with respect to a current block of a depth image;
a prediction block generator configured to generate a prediction block of the current block by using the prediction mode; and
an encoder configured to encode the depth image by using the prediction block to generate a bitstream.

14. The inter-layer video encoding apparatus of claim 13, wherein the SDC mode configuration unit configures at least one prediction mode of a DC mode, a planar mode, an angular mode, a depth modeling mode (DMM), and a most probable mode (MPM) as the SDC mode.
